(19) United States
(12) Patent Application Publication
(10) Pub. No.: US 2026/0370004 A1
(43) Pub. Date: Nov. 19, 2026

(54) AUTONOMOUS REAL-TIME VOLTAGE AND REACTIVE POWER CONTROL SYSTEMS AND METHODS OF A POWER DELIVERY SYSTEM

(71) Applicant: Schweitzer Engineering Laboratories, Inc., Pullman, WA (US)

(72) Inventors: Abdel Rahman Khatib, Pullman, WA (US); Orion Wheeler, Moscow, ID (US)

(73) Assignee: Schweitzer Engineering Laboratories, Inc., Pullman, WA (US)

(21) Appl. No.: 19/207,569

(22) Filed: May 14, 2025

(51) Int. Cl. H02J 3/18; H02J 13/12

(52) U.S. Cl. CPC H02J 3/18; H02J 13/12

(57) ABSTRACT

A control system may access control objective data that identifies a relative priority between multiple control objectives according to which to operate the electric power delivery system. By using priorities, different orders of control objectives may be used for different topologies, which may enable changing priorities among the different topologies without changing an underlying control algorithm. For example, in a ring bus configuration, the control system may control the voltage objective of the electric power delivery system while doing so in a manner that reduces or eliminates any contradictory adjustments to transformers and generators.

### BACKGROUND

This disclosure relates to electric power delivery systems. More particularly, this disclosure relates to voltage and/or reactive power (Q) control systems of an electric power delivery system.

Electric power delivery and/or distribution systems deliver electric power to residential and commercial consumers. Protection and control schemes may change a circuit breaker or disconnect state (e.g., open or closed) for breakers with the electric power delivery system. As circuit breakers are connected or disconnected to modify the electric power delivery system, control operations may be user-configured to correspond to the current configuration of buses. Doing so may be critical to maintaining the electric power delivery system, and doing so manually may be rigorous, time-consuming, inaccurate, and expensive. Each modification to the electric power delivery system (e.g., an addition or removal of a circuit or bus) may entail reconfiguration of the control operations. Consequently, reconfiguring the control operations, and reprogramming the logic to implement the reconfigured control operations, after a modification, may be an arduous and costly process.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a schematic diagram of an embodiment of an electric power delivery system, in accordance with an aspect of the present disclosure;

FIG. 2 is a block diagram of an example control system that may autonomously control the electric power delivery system, in accordance with an aspect of the present disclosure;

FIG. 3 is a flowchart of a method for autonomous control of the electric power delivery system of FIG. 1, in accordance with an aspect of the present disclosure;

FIG. 4 is a schematic diagram of an example of the electric power delivery system of FIG. 1 with one subsystem, four transformers, and four generators, in accordance with an aspect of the present disclosure;

FIG. 5 is a flowchart of a method for autonomous control of the electric power delivery system of FIG. 4, in accordance with an aspect of the present disclosure;

FIG. 6 is a schematic diagram of an example of the electric power delivery system of FIG. 1 with two subsystems, two transformers, and two generators, in accordance with an aspect of the present disclosure;

FIG. 7 is a flowchart of a method for autonomous control of the electric power delivery system of FIG. 6, in accordance with an aspect of the present disclosure;

FIG. 8 is a schematic diagram of an example of the electric power delivery system of FIG. 1 with one subsystem, four transformers, and zero generators, in accordance with an aspect of the present disclosure;

FIG. 9 is a flowchart of a method for autonomous control of the electric power delivery system of FIG. 8, in accordance with an aspect of the present disclosure;

FIG. 10 is a schematic diagram of an example of the electric power delivery system of FIG. 1 with five subsystems, three transformers, and three generators, in accordance with an aspect of the present disclosure;

FIGS. 11A and 11B are a flowchart of a method for autonomous control of the electric power delivery system of FIG. 10, in accordance with an aspect of the present disclosure;

FIG. 12 is a diagrammatic representation of an example control objective range of FIG. 2, in accordance with an aspect of the present disclosure;

FIG. 13 is a flowchart of a method for transformer tap control for bus voltage control of the electric power delivery system of FIG. 1 associated with a first example control objective instruction, in accordance with an aspect of the present disclosure;

FIG. 14 is a flowchart of a method for generator excitation control for voltage control of the electric power delivery system of FIG. 1 associated with a second example control objective instruction, in accordance with an aspect of the present disclosure;

FIG. 15 is a flowchart of a method for generator excitation control for reactive power (Q) control of the electric power delivery system of FIG. 1 associated with a third example control objective instruction, in accordance with an aspect of the present disclosure;

FIG. 16 is a flowchart of a method for sharing generator excitation, enabling sharing the reactive power (Q) among one or more generators in a voltage control mode of the electric power delivery system of FIG. 1 associated with a fourth example control objective instruction, in accordance with an aspect of the present disclosure; and

FIG. 17 is a flowchart of a method for tap equalization control among one or more transformers of the electric power delivery system of FIG. 1 associated with a fifth example control objective instruction, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase “A or B” is intended to mean A, B, or both A and B.

Several aspects of the embodiments described may be implemented as software modules or components. As used herein, a software module or component may include any type of computer instruction or computer-executable code located within a memory device and/or transmitted as electronic signals over a system bus or wired or wireless network. A software module or component may, for instance, include physical or logical blocks of computer instructions, which may be organized as a routine, program, object, component, data structure, or the like, and which performs a task or implements a particular abstract data type.

An electric power system (e.g., a power delivery and/or distribution system) may include numerous devices (e.g., potential transformers, current transformers, and so on) electrically connected to numerous other devices. Electric power delivery and/or distribution systems deliver electric power to residential and commercial consumers. Protection and control schemes may adapt to a present circuit breaker or disconnect state (e.g., open or closed) for breakers with the electric power delivery system, which may change a number of subsystems and what types and numbers of devices are coupled to the respective subsystems. As circuit breakers are connected or disconnected to modify the electric power delivery system, control operations may be user-configured to correspond to the current configuration of busses, which may change how subsystems and devices are interconnected. The electrical connectivity between devices, busses, and subsystems may change how control of operational parameters is performed within the electric power delivery and/or distribution systems. Indeed, some control objectives that may apply in a first configuration may not apply in a second configuration. Keeping control operations aligned with present configurations may be critical to maintaining the electric power delivery and/or distribution systems, and doing so manually may be rigorous, time-consuming, inaccurate, and expensive. Each modification to the electric power delivery system (e.g., an addition or removal of a circuit or bus) may entail reconfiguration of the control operations. Consequently, reconfiguring the control operations, and reprogramming the logic to implement the reconfigured control operations, after a modification may be an arduous and costly process.

To reduce the programming and testing time for electric power delivery systems, a data processing system-managed autonomous control system is described herein. By providing control objectives, relative priorities, and present configuration data of the electric power delivery system to the data processing system, the data processing system may determine when respective control objectives apply and an operational flow to apply the control objectives without further invention from an operator.

To elaborate, controlling tap positions of one or more transformers to maintain a desired bus voltage and concurrently controlling the excitation system of one or more generators in different excitation control modes (e.g., voltage control mode, voltage droop control mode, power factor mode, reactive power mode) to maintain a desired reactive power (Q) in different bus configurations is a challenging problem facing many electric power delivery systems. This may be also true for electric power delivery systems that have had bus configuration systems upgraded from a radial system to a ring bus configuration, or a green industry electric power delivery system that has designed a substation as a ring bus configuration. Although the ring bus configuration adds resiliency and reliability to an electric power delivery system, the ring bus configuration adds complexity in that the topology is to be tracked, the transformers tapped, and the generator controlled in a control scheme that reduces or removes both the transformers and the generators being operated to make conflicting adjustments when controlling the same voltage objective.

In addition to the bus voltage and generator reactive power (Q) objectives, reducing the transformer circulating current by adjusting respective tap positions of the transformers (e.g., transformer tap equalization when the electric power delivery system employs similar transformers) is another objective that may be accomplished without jeopardizing bus voltage and reactive power (Q). If a generator is connected to a bus with an uncontrollable transformer, the objective of the generator may switch from reactive power (Q) control to voltage control to maintain the bus voltage since maintaining reactive power (Q) may become less of a priority in that scenario.

Systems and methods described herein may provide an autonomous, real time control system able to control the electric power delivery system based on setpoints. The control system may adjust the operation of the electric power delivery system to align with the setpoints overtime responsive to any changes in configuration overtime. The control system may have the flexibility to prioritize control objectives based on system topology and customer preferences. For example, the control system may identify when a primary goal is to be a bus voltage control objective, when a secondary goal is to be a generator reactive power (Q) control objective, and when a tertiary goal is to be minimizing circulating current among two or more parallel transformers (e.g., transformer tap equalization). Moreover, the control system may coordinate and handshake between one or more transformers and one or more generators to achieve the control objectives based on measuring operational parameters (e.g., field system data) of the electric power delivery system, such as voltages or reactive power (Q), and/or based on tracking system topology (e.g., association data).

A data processing system of the control system may access control objective data that identifies a relative priority between multiple control objectives according to which to operate the electric power delivery system. By using priorities, different orders of control objectives may be used for different topologies, which may enable changing priorities among the different topologies without changing an underlying control algorithm.

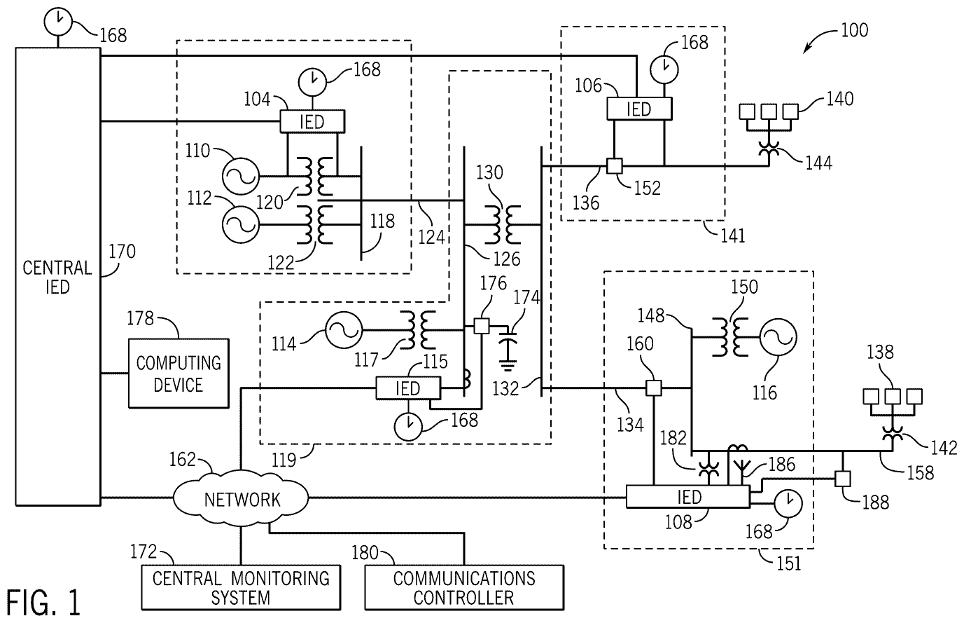

With the preceding in mind, FIG. 1 is a schematic diagram of an electric power delivery system 100 that may generate, transmit, and/or distribute electric energy to various loads (e.g., different structures). The electric power delivery system 100 may use various intelligent electronic devices (IEDs) 104, 106, 108, 115 to control certain aspects of the electric power delivery system 100. As used herein, an IED (e.g., the IEDs 104, 106, 108, 115) may refer to any processing-based device that monitors, controls, automates, and/or protects monitored equipment within the electric power delivery system 100. Although the present disclosure primarily discusses the IEDs 104, 106, 108, 115 as relays, such as a remote terminal unit, a differential relay, a distance relay, a directional relay, a feeder relay, an overcurrent relay, a voltage regulator control, a voltage relay, a breaker failure relay, a generator relay, and/or a motor relay, additional IEDs 104, 106, 108, 115 may include an automation controller, a bay controller, a meter, a recloser control, a communications processor, a computing platform, a programmable logic controller (PLC), a programmable automation controller, an input and output module, and the like. Moreover, the term “IED” may be used to describe an individual IED or a system including multiple IEDs.

For example, the electric power delivery system 100 may be monitored, controlled, automated, and/or protected using the IEDs 104, 106, 108, 115, and a central monitoring system 172 (e.g., an industrial control system). In general, the IEDs 104, 106, 108, 115 may be used for protection, control, automation, and/or monitoring of equipment in the electric power delivery system 100. For example, the IEDs 104, 106, 108, 115 may be used to monitor equipment of many types, including electric power lines, current sensors, busses, switches, circuit breakers, reclosers, transformers, autotransformers, tap changers, voltage regulators, capacitor banks, generators, motors, pumps, compressors, valves, and a variety of other suitable types of monitored equipment.

A common time signal may be distributed throughout the electric power delivery system 100. Utilizing a common time source may ensure that IEDs 104, 106, 108, 115 have a synchronized time signal that can be used to generate time synchronized data, such as synchrophasors. In various embodiments, the IEDs 104, 106, 108, 115 may receive a common time signal 168. The time signal may be distributed in the electric power delivery system 100 using a communications network 162 and/or using a common time source, such as a Global Navigation Satellite System (“GNSS”), or the like.

The IEDs 104, 106, 108, 115 may be used for controlling various other equipment of the electrical electric power delivery system 100. By way of example, the illustrated electric power delivery system 100 includes electric generators 110, 112, 114, 116 and power transformers 117, 120, 122, 130, 142, 144, 150. The electric power delivery system 100 may also include electric power lines 124, 134, 136, 158 and/or busses 118, 126, 132, 148 to transmit and/or deliver power, circuit breakers 152, 160, 176 to control flow of power in the electric power delivery system 100, and/or loads 138, 140 to receive the power in and/or from the electric power delivery system 100. A variety of other types of equipment may also be included in the electric power delivery system 100, such as a voltage regulator, a capacitor (e.g., a capacitor 174), a potential transformer (e.g., a potential transformer 182), a current sensor (e.g., a wireless current sensor (WCS) 184), an antenna (e.g., an antenna 186), a circuit breaker (e.g., a circuit breaker 188), and other suitable types of equipment useful in power generation, transmission, and/or distribution.

A substation 119 may include the electric generator 114, which may be a distributed generator and which may be connected to the bus 126 through the power transformer 117 (e.g., a step-up transformer). The bus 126 may be connected to the bus 132 (e.g., a distribution bus) via the power transformer 130 (e.g., a step-down transformer). Various electric power lines 136, 134 may be connected to the bus 132. The electric power line 136 may lead to a substation 141 in which the electric power line 136 is monitored and/or controlled using the IED 106, which may selectively open and close the circuit breaker 152. The load 140 may be fed from the electric power line 136, and the power transformer 144 (e.g., a step-down transformer) in communication with the bus 132 via electric power line 136 may be used to step down a voltage for consumption by the load 140.

The electric power line 134 may deliver electric power to the bus 148 of the substation 151. The bus 148 may also receive electric power from the distributed electric generator 116 via the power transformer 150. The electric power line 158 may deliver electric power from the bus 148 to the load 138 and may include the power transformer 142 (e.g., a step-down transformer). The circuit breaker 160 may be used to selectively connect the bus 148 to the electric power line 134. The IED 108 may be used to monitor and/or control the circuit breaker 160 as well as the electric power line 158.

According to various embodiments, the central monitoring system 172 may include one or more of a variety of types of systems. For example, the central monitoring system 172 may include a supervisory control and data acquisition (SCADA) system and/or a wide area control and situational awareness (WACSA) system. A central IED 170 (e.g., a switch) may be in communication with the IEDs 104, 106, 108, 115. The IEDs 104, 106, 108, 115 may be remote from the central IED 170 and may communicate over various media. For instance, the central IED 170 may be directly in communication with the IEDs 104, 106 and may be in communication with the IEDs 108, 115 via the communications network 162.

The central IED 170 may enable or block data flow between any of the IEDs 104, 106, 108, 115. For example, during operation of the electric power delivery system 100, the IEDs 104, 106, 108, 115 may transmit data with one another to perform various functionalities for the electric power delivery system 100 by initially transmitting the data to the central IED 170. The central IED 170 may receive the data and may subsequently transmit the data to an intended recipient of the data. The central IED 170 may also control data flow between one of the IEDs 104, 106, 108, 115 and another device communicatively coupled to the central IED 170, such as a computing device 178. For instance, the computing device 178 may be a laptop, a mobile phone, a desktop, a tablet, or another suitable device with which a user (e.g., a technician, an operator) may interact. As such, the user may utilize the computing device 178 to receive data, such as operating data, from the electric power delivery system 100 via the central IED 170 and/or to send data, such as a user input, to the electric power delivery system 100 via the central IED 170. Thus, the central IED 170 may enable or block operation of the electric power delivery system 100 via the computing device 178.

A communications controller 180 may interface with equipment in the communications network 162 to autonomously control the electric power delivery system 100 that facilitates communication between the central IED 170, the IEDs 104, 106, 108, 115, and/or the central monitoring system 172. In various embodiments, the communications controller 180 may interface with a control plane (not shown) in the communications network 162. Using the control plane, the communications controller 180 may direct the flow of data within the communications network 162. Indeed, the communications controller 180 may communicate with the central IED 170 to instruct the central IED 170 to transmit certain data (e.g., data associated with a certain set of characteristics or information) to a particular destination (e.g., an intended recipient) using flows, matches, and actions defined by the communications controller 180.

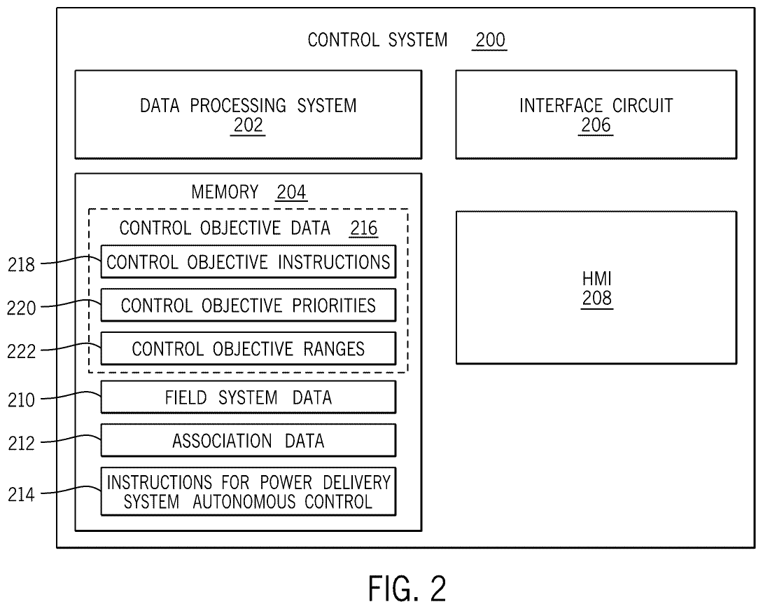

FIG. 2 is a block diagram of an example control system 200 that may autonomously control the electric power delivery system 100. The central IED 170 of FIG. 1 may be an example of the control system 200. The control system 200 may include a data processing system 202 and a memory 204. For example, the control system 200 may be a remote terminal unit, the central monitoring system 172, or the like.

The data processing system 202 may include any suitable processing circuitry, such as a computer, a field programmable gate array (FPGA), a programmable logic device (PLD), a programmable logic controller (PLC), or the like. The control system 200 may include an interface circuit 206. The interface circuit 206 may receive data that the data processing system 202 may use to make control decisions. HMI 208 may be used to present statuses to an operator, to receive configurations or setpoints that the control system 200 is to operate in accordance, or the like. The HMI 208 may include a display that presents image content, light emitting circuitry, or status indictor circuitry, or the like.

The interface circuit 206 may enable any suitable wired or wireless communication. The communication may be enabled over the communication network 162 of FIG. 1. For example, the interface circuit 206 may include radio front end circuitry to enable radio frequency wireless communications between the control system 200 and one or more components of FIG. 1, such as IEDs 104, 106, 108, 115, or the like.

The memory 204 may store data received via the interface circuit 206, such as field system data 210. The field system data 210 may include data obtained in real-time from one or more sensors (e.g., sensed value indicating present operations like a present bus voltage, a present power factor, a present reactive power output, or the like) and/or status-reporting components of an electric power delivery system. For example, the IEDs 104, 106, 108, 115 may report statuses to the control system 200 in association with controlling various equipment of the electrical electric power delivery system 100, which may be stored as field system data 210 in the memory 204. The memory 204 may store association data 212. The association data 212 may include data that identifies one or more associations between respective devices of one or more devices and respective subsystems of one or more subsystems of an electric power delivery system. The association data 212 may include a one-line representation of the electric power delivery system. In some cases, control circuitry of the electric power delivery system may report real-time statuses to the control system 200, which may provide an indication of real-time connections within the electric power delivery system. For example, the association data 212 may indicate that the generator 110 is associated with the transformer 120 and the bus 118 or any of the connections illustrated in FIG. 1. The control system 200, via the data processing system 202 may determine a number of subsystems at least in part by determining a topology of the interconnections between respective disconnect switches and between respective power sources and determining the number of subsystems based on the topology. Association data 212 may be changed over time to mirror real-time configurations of the electric power delivery system, which may help reduce a likelihood or eliminate a possibility that the control system 200 makes a control decision based on an outdate configuration.

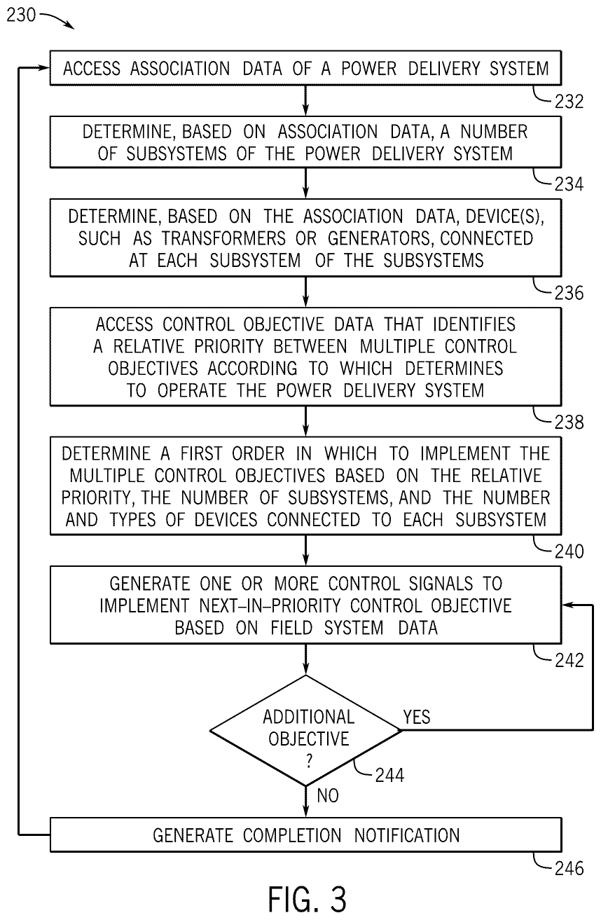

The memory 204 may store instructions 214 for electric power delivery system autonomous control. The data processing system 202 may execute the instructions 214, which may cause the data processing system 202 to perform operations, such as operations of FIG. 3 described herein. For example, the data processing system 202, in executing the instructions 214, may cause the control system 200 to access control objective data 216 that indicates a relative priority (e.g., via control objective priorities 220) between control objectives to be implemented across one or more subsystems. The data processing system 202, in executing the instructions 214, may cause the control system 200 to determine a first order in which to implement the control objectives based on the relative priority between the control objectives and based on one or more associations indicated by the association data 212. The association data 212 may indicate one or more associations between respective devices of the one or more devices and respective subsystems of the one or more subsystems. The data processing system 202, in executing the instructions 214, may cause the control system 200 to generate one or more control signals to implement the control objectives in the first order. The data processing system 202, in executing the instructions 214, may cause the control system 200 to implement the control objectives sequentially according to the first order in each of the one or more subsystems over at least partially overlapping time durations.

For example, the data processing system 202, in executing the instructions 214, may cause the control system 200 to determine that a first-in-priority control objective of the control objectives is not completed relative to a first subsystem of the one or more subsystems. The data processing system 202 may do so by comparing field system data 210 to one or more setpoints indicated in the control objective ranges 222. When outside setpoint ranges associated with the one or more setpoints, the data processing system 202 may cause the control system 200 to generate a control signal to cause an adjustment in a power delivered by the electric power delivery system based on the first-in-priority control objective relative to the first subsystem. For example, the control signal may operate a generator to increase a reactive power (Q) supplied or to change a tap of a transformer to increase a voltage to implement an adjustment identified by the data processing system 202 based on comparing field system data 210 to one or more setpoints indicated in the control objective ranges 222. The adjustment may be implemented by one or more control signals generated by the data processing system 202, where the one or more control signals may cause one or more operational parameters associated with the subsystem to change responsive to receiving the control signals.

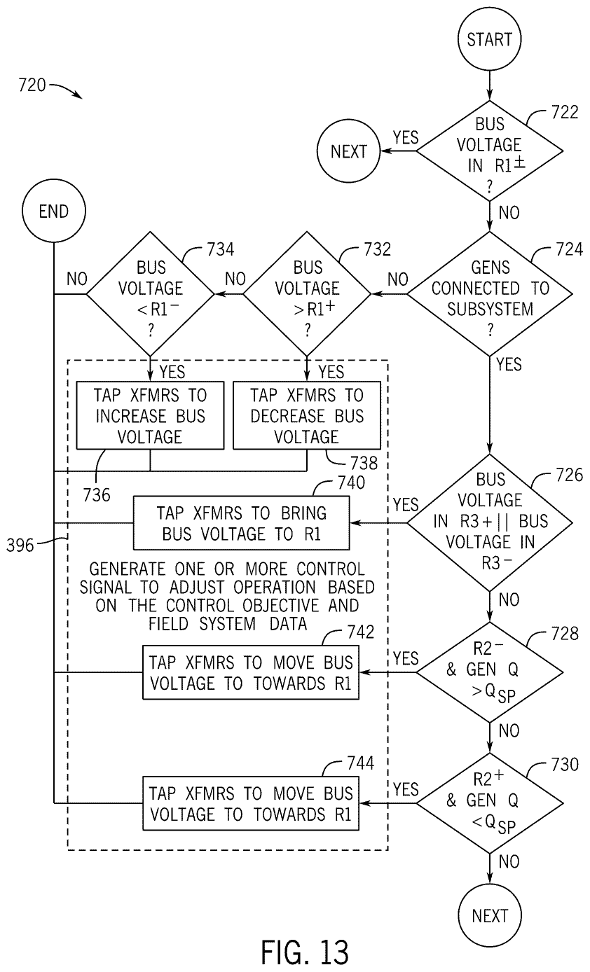

The memory 204 may store control objective data 216, which may include control objective instructions 218, control objective priorities 220 (e.g., control objective priority data), and control objective ranges 222 (e.g., control objective range data). The control objective instructions 218 may include instructions for respective control objectives of multiple control objectives able to be performed by the control system 200. The control objectives may be performed relative to control objective ranges 222. The control objective ranges 222 may indicate a range of voltages, currents, power, or the like by which the control system 200 is to operate the electric power delivery system in accordance. For example, respective sets of instructions of the control objective instructions 218, when executed by the data processing system 202, may cause the control system 200 to perform transformer tapping voltage control, generator voltage control, generator reactive power (Q) control, generator reactive power (Q) sharing, transformer tap equalization control, or the like relative to control objective ranges 222 that indicate a voltage threshold by which to perform the transformer tapping voltage control, the generator voltage control, the generator reactive power (Q) control, the generator reactive power (Q) sharing, the transformer tap equalization control, or the like. Examples of control system 200 operations enabled through executing the control objective instructions 218 may be described relative to at least FIGS. 13-17.

The control objective priorities 220 may indicate conditions that are to be met before a respective set of instructions of the control objective instructions 218 may be executed. For example, the control objective priorities 220 may indicate that instructions for a voltage bus with transformer control objective are associated with a relatively highest priority and are to be performed for subsystems connected to any number of transformers. The control objective priorities 220 may include indications of the first-in-priority control objective having a relatively greater priority than a second-in-priority control objective. For example, when the one or more devices of a subsystem includes a transformer, the first-in-priority control objective may corresponds to maintaining a voltage bus of the transformer between a first voltage range not to exceed beyond a second voltage range.

Example control objectives that may be implemented via the control system 200 may include transformer tap control for bus voltage control, generator excitation control for reactive power (Q) control, generator excitation control for voltage control, generator excitation sharing to share the reactive power (Q) among two or more generators in a voltage control mode, transformer tap equalization control to reduce transformer circulating current with reduced voltage disturbance, which may be based on simultaneous tap and/or cascade tap, or the like. Additional control objectives may include selection of the equalized tap position for the tap equalization control if the average tap position is a non-integer number. Additional control objectives may include a selective deadline or operational setpoint for voltage control based on a transformer tap step size and calculations to limit the hunting possibility between multiple objectives. Additional control objectives may include application of a hunting detection operation to detect any hunting not considering by the algorithm. When hunting is detected for one transformer, this transformer may be removed from the controllable devices and the rest of the transformers (e.g., one or more other transformers) may be used by the control system 200 to maintain the control objectives (e.g., achieve the operational setpoints).

The data processing system 202 analyzing the control objective priorities 220 relative to the association data 212 for a given subsystem may determine whether and when to apply (or to skip) respective instruction sets based on the priority indication and the condition indication. Indeed, the control objective priorities 220 may indicate that instructions for a voltage bus with generator and reactive power (Q) power sharing control objective are associated with a relatively second highest priority (e.g., second to the relatively highest priority control objective) and are to be performed for subsystems connected to any number of generators that are not connected to any transformers. The control objective priorities 220 may indicate that instructions for a generator reactive power (Q) control objective are associated with a relatively third highest priority (e.g., after the relatively second highest priority control objective) and are to be performed for subsystems connected to any number of generators and any number of transformers. The control objective priorities 220 may indicate that instructions for a minimizing circulating current control objective are associated with a lowest priority (e.g., after the relatively third highest priority control objective) and are to be performed for subsystems connected to two or more transformers. These examples of instructions and priorities of the control objective data 216 are examples of control objectives that the data processing system 202 may implement in autonomous control operations. It should be understood that additional or alterative control objectives may be performed herein.

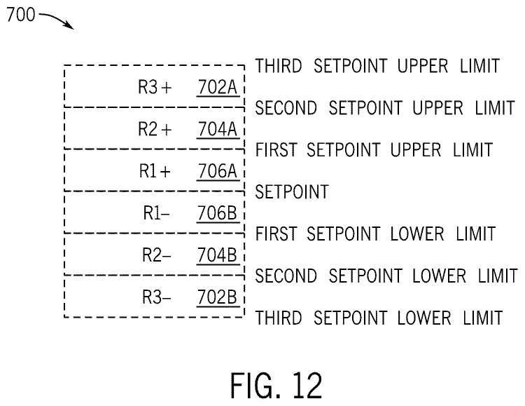

Furthermore, the memory 204 may store instructions, like the instructions 214 for electric power delivery system autonomous control. Power delivery system autonomous control operations may be based on the control objective data 216, the field system data 210, the association data 212, or the like. By executing the instructions 214, the data processing system 202 may perform electric power delivery system autonomous control operations to operate devices of the electric power delivery system within the control objective ranges 222. The control system 200 may do so based on the control objective priorities 220, which may identify a relative priority between multiple control objectives of an electric power delivery system. Examples of these operations may be described at least relative to FIGS. 3-11, where examples of respective control objectives may be described at least relative to FIGS. 12-17. The HMI 208 may include a display, an indicator light, or other suitable output device through which the data processing system 202 may generate and present an indication that electric power delivery system autonomous control operations are completed or are successfully being performed on an ongoing basis.

With this in mind, FIG. 3 is a flowchart of a method 230 for autonomous control of the electric power delivery system of FIG. 1. For ease of description, the method 230 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 230. In some embodiments, the method 230 may be implemented by executing instructions stored in a tangible, non-transitory, computer-readable medium, such as a memory, using the data processing system 202. For example, the method 230 may be performed at least in part by one or more software components, such as the control development software, one or more software applications of the IEDs 104, 106, 108, 115, and the like. While the method 230 is described using operations in a specific sequence, it should be understood that the present disclosure contemplates that the described operations may be performed in different sequences than the sequence illustrated, and certain described operations may be skipped or not performed altogether.

In process block 232, the data processing system 202 may access the association data 212. The association data 212 may include a line diagram of a topology of the electric power delivery system, which may be updated by the data processing system 202 over time in response to change data or status changes received via the interface circuit 206.

In process block 234, the data processing system 202 may determine, based on the association data 212, a number of subsystems of an electric power delivery system. The electric power delivery system may correspond to the electric power delivery system 100 of FIG. 1. A subsystem may connect to a utility bus but otherwise be separated from other busses of the electric power delivery system.

In process block 236, the data processing system 202 may determine, based on the association data 212, one or more devices connected to each subsystem of the subsystems identified in process block 234. Examples of the one or more devices include transformers and generators.

In process block 238, the data processing system 202 may access control objective data 216 that identifies a relative priority between multiple control objectives according to which determines to operate the electric power delivery system. The relative priorities may be indicated via the control objective priorities 220. The relative priorities may correspond to priorities set based on customer preferences associated with more than one electric power delivery system. The relative priorities may correspond to priorities set based on a topology of the electric power delivery system. For example, a ring distribution bus topology may be associated with different relative priorities than a parallel feeder bus topology.

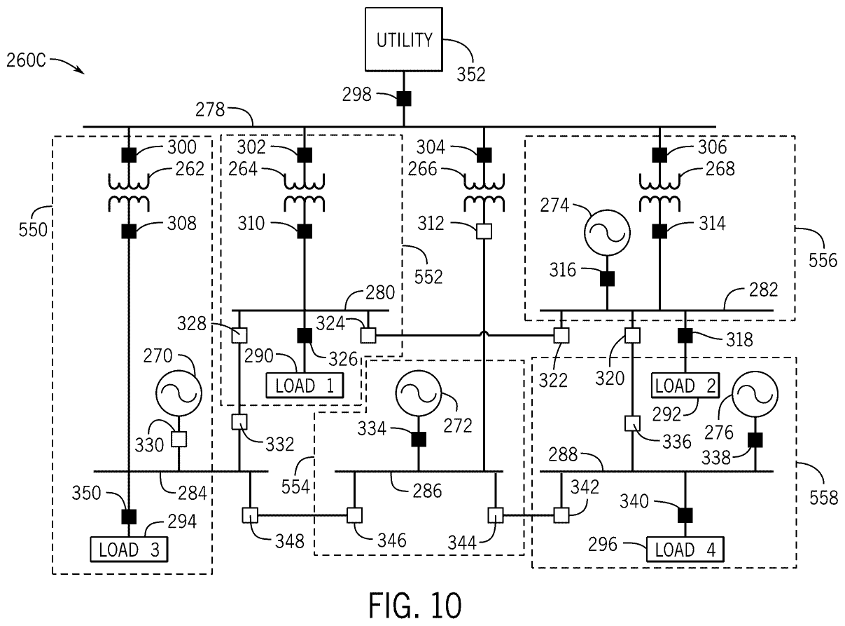

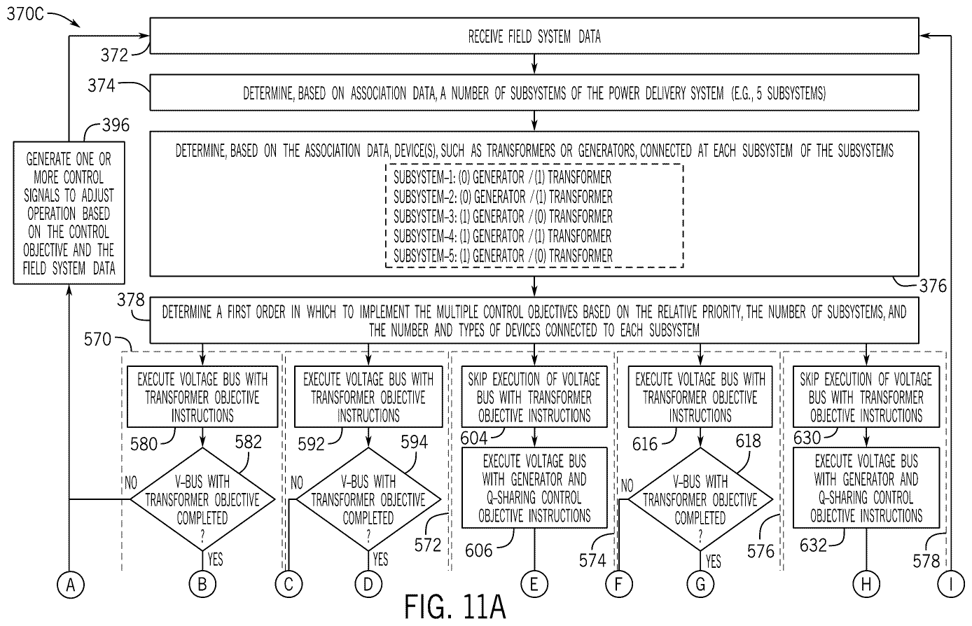

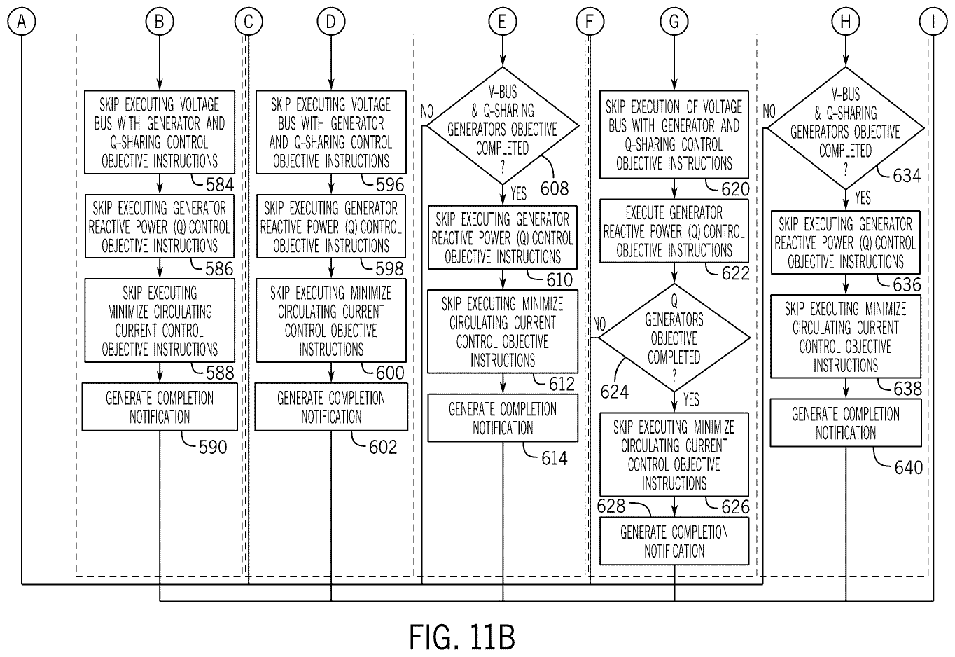

In process block 240, the data processing system 202 may determine a first order in which to implement the multiple control objectives based on the relative priority, the number of subsystems, and the number and types of devices connected to each subsystem. The first order determined may cause performance of the respective control objectives in the relative priority order indicated with some of the control objectives not being performed based on the number of subsystems or the number and types of devices connected to each subsystem. For example, each subsystem may be controlled on a same priority order of the same control objectives, however some control objectives may not apply for a respective subsystem and so may be skipped when controlling the subsystem. The timing of when that control objective is skipped may be consistent across similarly situated subsystems, as is described further herein relative to at least FIGS. 10-11. In that example, the first subsystem and the second subsystem are controlled based on a first-in-priority operation and skip a second-in-priority operation, where the second-in-priority operation is in a second performance position in the first order for each system such that other subsystems (e.g., subsystem 3) that are controlled based on the second-in-priority operation do so after the first-in-priority operation is performed or skipped. In other words, the first order that is determined may set a global priority order of the control objectives for each of the subsystems, where control of the respective subsystems may skip or implement respective control objectives in the first order based on the number and types of devices connected to that respective subsystem.

In process block 242, the data processing system 202 may generate one or more control signals to implement, based on field system data 210, first, a first-in-priority control objective, and, later, a next-in-priority control objective. Generating a control signal at block 242 to implement a respective control objective may involve the data processing system 202 generating a control signal to skip that respective control objective. Generating a control signal at block 242 to implement a respective control objective may involve the data processing system 202 generating a control signal to execute that respective control objective. A respective control objective may be executed when the data processing system 202 deems that respective control objective applies to the subsystem being controlled. A respective control objective may be skipped when the data processing system 202 deems that respective control objective does not apply to the subsystem being controlled. Control objectives may be implemented (e.g., skipped or executed) based on the relative priorities referenced by the data processing system 202 via the control objective priorities 220 data. The various control objectives may be implemented at an at least partially overlapping time duration for each of the subsystems. In some cases, the various control objectives may be implemented simultaneously in each of the subsystems. When implementing respective control objectives in a respective subsystem, the data processing system 202 may generate control signals to implement the control objectives in the first order. The data processing system 202 may generate one or more control signals to implement the first-in-priority control objective in a first device of the first subsystem, which may entail repeating control operations until the operation of the first device is within the control objective ranges 222. These control operations may be performed at a simultaneous or at least partially overlapping time to control operations applied to a second device of a second subsystem. The data processing system 202 may generate one or more control signals to implement the first-in-priority control objective in the second device of the second subsystem, which may entail repeating control operations until the operation of the second device is within the control objective ranges 222. Since adjusting an operation of the second device may change an operation of the first device, adjustments may be performed simultaneously or at an at least partially overlapping time, and repeatedly over time until each of the respective operations of the first device, second device, and any other devices are within the control objective ranges 222 deemed operationally suitable. The data processing system 202 may generate the one or more control signals based on executing the control objective instructions 218, which may include instructions that, when executed, cause the data processing system 202 to perform operations of respective control objectives.

In decision block 244, the data processing system 202 may determine whether an additional control objective is included in the first order in process block 240. When the additional control objective is present, the data processing system 202 may generate one or more additional control signals to implement the next-in-priority control objective based on the field system data 210. When the additional control objective is not present, the data processing system 202 may proceed with the method 230.

In process block 246, the data processing system 202 may generate a completion notification indicating that each control objective has been performed. The completion notification may indicate that each control objective has been performed in the first order, which may be in accordance with priority data associated with a customer or topology type of the electric power delivery system. The data processing system 202 may cause presentation of the completion notification via the HMI 208. After operations of process block 246, the data processing system 202 may continue on to repeat perform operations of the process block 232. The data processing system 202 may repeat performing operations of method 230 to continue adjusting the electric power delivery system over time and in response to real-time obtained sensing data or statuses from the electric power delivery system.

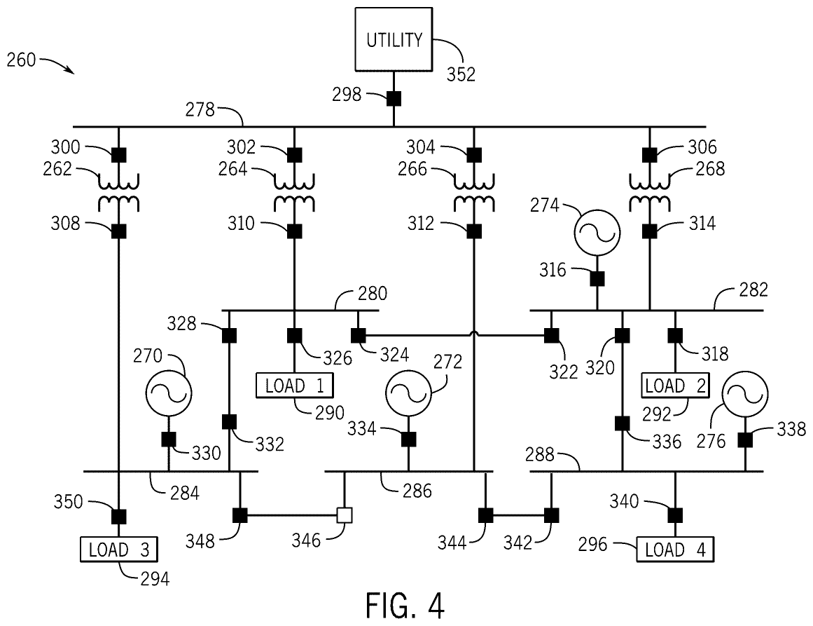

FIG. 3 described an overview of the method 230 that the data processing system 202 may perform when controlling devices of an electric power delivery system based on autonomous control operations. FIGS. 4-11B illustrate a few examples of the autonomous control operations as applied to different topologies.

An electric power delivery system may include one or more subsystems, which may distribute power to one or more devices. The electric power delivery system may include a control system able to communicate with the one or more devices, or with control circuitry associated with respective devices of the one or more devices. The control system may access control objective data that indicates a relative priority between control objectives to be implemented across each of the subsystems. The control system may determine a first order in which to implement the control objectives based on the relative priority between the control objectives and based on one or more associations between respective subsystems and respective devices. The control system may generate one or more control signals to implement the control objectives in the first order at some or each of the one or more devices.

For example, FIG. 4 is a schematic diagram of an example of an electric power delivery system 260. The electric power delivery system 260 may be an example of the electric power delivery system 100. The electric power delivery system 260 may include one subsystem, four transformers 262, 264, 266, 268, and four generators 270, 272, 274, 276. The electric power delivery system 260 also includes busses 278, 280, 282, 284, 286, 288 and loads 290, 292, 294, 296.

To control electrical interconnection between the busses, loads, transformers, and generators, the electric power delivery system 260 includes switches or circuit breakers 298, 300, 302, 304, 306, 308, 310, 312, 314, 316, 318, 320, 322, 324, 326, 328, 330, 332, 334, 336, 338, 340, 342, 344, 346, 348, 350. The circuit breaker 346 may be open. The circuit breakers 298, 300, 302, 304, 306, 308, 310, 312, 314, 316, 318, 320, 322, 324, 326, 328, 330, 332, 334, 336, 338, 340, 342, 344, 348, 350 may be closed. These may be examples of disconnect switches which may connect respective devices to one or more subsystems. It is noted that the control system 200 may access indications of associations between the subsystems and the devices, such as indications of placements of circuit breakers and/or electrical couplings between circuit breakers. The control system 200, in accessing the associations and a present configuration of the electric power delivery system 260, may determine a number of subsystems and a number and type of devices coupled at each subsystem.

Since the circuit breaker 298 is closed, a utility 352 may supply electrical signals to the bus 278. Electrical interconnections may distribute the electrical signals to the loads 290, 292, 294, and 296. The supplied power to the loads 290, 292, 294, and 296 may be supplemented by supplied power from the generators 270, 272, 274, 276. Transformers 262, 264, 266, 268 may step down or step up a voltage based on a tap setting, which may set a winding ratio and change by how much the voltage is stepped up or down when transmitted through the transformers. The tap setting may be changed based on one or more control signals being received by a respective transformer, such as at an on-load tap changer (OLTC) operable to adjust a specific point tapped on respective windings of that transformer in response to the one or more control signals, which may adjust a voltage and/or current output from that transformer post-adjustment. Although the circuit breaker 346 is open, there is one subsystem depicted in FIG. 4 based on the connections between circuit breakers 324, 322, as well as the connections between circuit breakers 342, 344, between circuit breakers 320, 336, and between circuit breakers 328, 332. In other words, to be considered one subsystem, buses 280, 282, 284, 286, 288 are to be connected through the path of closed circuit breakers 332, 328, 324, 322, 320, 336, 342, 344.

When considering control of the electric power delivery system 260, the two main controllable devices may be the transformers 262, 264, 266, 268 and the generators 270, 272, 274, 276. The transformers 262, 264, 266, 268 may respectively include on-load tap changers (OLTCs), which may be remotely controllable. The OLTC of a transformer may change one or more parameters of that transformer in response to receiving a control signal or accessing an instruction, such as in a register. For example, a parameter may be a tap setting, which may be remotely controllable in response to the control signal. The control system 200 may generate the control signal based on operations performed by the data processing system 202, which may be described further herein. The generators 270, 272, 274, 276 may be operated in a voltage droop or other suitable voltage mode. Some of the control objective described herein may work with other generator modes. Deadbands (e.g., range regions 702, 704, 706 described herein) may be changeable and may be adjusted by through writing adjusted control objective ranges 222 to the memory 204.

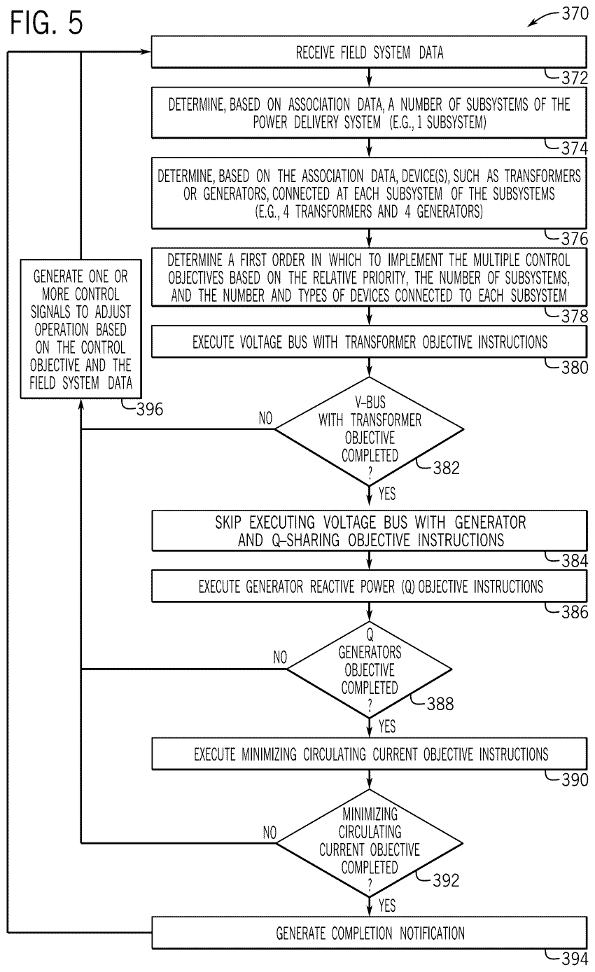

FIG. 5 is a flowchart of a method for autonomous control of the electric power delivery system 260 of FIG. 4. For ease of description, the method 370 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 370. In some embodiments, the method 370 may be implemented by executing instructions stored in a tangible, non-transitory, computer-readable medium, such as a memory, using the data processing system 202. For example, the method 370 may be performed at least in part by one or more software components, such as the control development software, one or more software applications of the IEDs 104, 106, 108, 115, and the like. While the method 370 is described using operations in a specific sequence, it should be understood that the present disclosure contemplates that the described operations may be performed in different sequences than the sequence illustrated, and certain described operations may be skipped or not performed altogether.

In process block 372, the data processing system 202 may receive field system data 210. The field system data 210 may indicate present voltages, reactive power (Q), current, real power, or the like delivered or present in the electric power delivery system 260 at a time of control operation being performed. These present operating conditions represented in the field system data 210 may provide an indication of a current operation which may be adjusted over time through the application of one or more control signals to adjust one or more operations of the electric power delivery system 260 based on the outcomes of the various control objectives, as described herein.

In process block 374, the data processing system 202 may determine, based on association data 212, a number of subsystems of the electric power delivery system 260. The data processing system 202 may determine that the electric power delivery system 260 has one subsystems based on how each of the busses are interconnected and based on indications of whether any of the circuit breakers are open (e.g., indication that circuit breaker 346 is open, indication that circuit breakers 298, 300, 302, 304, 306, 308, 310, 312, 314, 316, 318, 320, 322, 324, 326, 328, 330, 332, 334, 336, 338, 340, 342, 344, 348, 350 are closed). The association data 212 may indicate the electrical connections between devices and circuit breakers of an electric power delivery system, like the electric power delivery system 260. As states of circuit breakers change (e.g., are opened or closed), the association data 212 may be updated in the memory 204 to reflect the changed states. For example, the data processing system 202 may receive an indication of the present circuit breaker state and write the present circuit breaker state to the memory 204 in the association data 212. Although the circuit breaker 346 is open, the data processing system 202 may determine that there is one subsystem depicted in FIG. 4 based on one or more electrical connections between circuit breakers 324, 322, as well as one or more electrical connections between circuit breakers 342, 344, between circuit breakers 320, 336, and between circuit breakers 328, 332. In other words, to be considered one subsystem, buses 280, 282, 284, 286, 288 are to be connected through the path of closed circuit breakers 332, 328, 324, 322, 320, 336, 342, 344. As such, the association data 212 may include indications of the circuit breaker states, electrical connections between circuit breakers, busses, devices (e.g., transformers, generators), and the like, like any other suitable information that may be helpful for the data processing system 202 to access when determining control signals or an adjustment to be applied to the electric power delivery system 260 relative to methods described herein.

In process block 376, the data processing system 202 may determine, based on the association data 212, a number of devices connected at each subsystem of the subsystems. Here, the data processing system 202 determines the number of devices connected overall since there is one subsystem. The electric power delivery system 260 includes four transformers 262, 264, 266, 268, and four generators 270, 272, 274, 276. Thus, the data processing system 202 in process block 376 may identify that eight devices, four transformers and four generators, are connected at the first subsystem of the electric power delivery system 260.

In process block 378, the data processing system 202 may determine a first order in which to implement the multiple control objectives based on the relative priority, the number of subsystems, and the number and types of devices connected to each subsystem. For the electric power delivery system 260, the data processing system 202 may determine the first order as (1) voltage bus with transformer control objective, (2) voltage bus with generator and reactive power (Q) power sharing control objective, (3) generator Q power control objective; and (4) minimizing circulating current control objective. The data processing system 202 may determine the first order based on the topology of the electric power delivery system 260. The data processing system 202 may determine to skip or execute respective control objective instructions corresponding to the first order based on the number and the types of devices connected to each subsystem. The data processing system 202 may determine to skip or execute respective control objective instructions repeatedly for each subsystem. Here, the data processing system 202 may determine to execute the voltage bus with transformer control objective (based on there being at least one transformer coupled to the subsystem), to skip the voltage bus with generator and reactive power (Q) sharing control objective (based on there not being at least one generator coupled to the subsystem without any transformers being coupled to the subsystem), to execute the generator reactive power (Q) control objective (based on there being at least one transformer and at least one generator coupled to the subsystem), and to execute the minimizing circulating current control objective (based on there being at least two transformers coupled to the subsystem). The data processing system 202 may maintain an indication of the first order for each iteration of the method 370, where the data processing system 202 may update the first order of execution relative to a change in the association data 212, which may change which operations apply of those indicated in the first order.

In process block 380, the data processing system 202 may execute the voltage bus with transformer control objective instructions. These instructions may cause the data processing system 202 to perform at least some of the operations described herein relative to FIG. 13.

For example, in decision block 382, the data processing system 202 may determine whether the bus voltage with the transformer is within a range of the control objective ranges 222, and thus the data processing system 202 may determine whether the voltage bus with transformer control objective is completed. An example range may be described herein relative to FIG. 12 and/or FIG. 13.

When the data processing system 202 determines that the bus voltage is outside the range of the control objective ranges 222, the data processing system 202 may proceed to process block 396. In process block 396, the data processing system 202 may generate one or more control signals to adjust an operation of the electric power delivery system based on the control objective and the field system data 210 received at process block 372. The field system data 210 may indicate a present operating condition or parameter, which may be used to determine how much of an adjustment to be applied through the control signals. If the bus voltage with the transformer is outside the range, the data processing system 202 may generate or cause generation of a control signal to adjust a tap the transformer to decrease the bus voltage if the bus voltage is greater than an upper voltage level limit of the range. For example, the data processing system 202 may generate or cause generation of a control signal to adjust a tap the transformer to decrease the bus voltage by 1%, 5%, 10%, or other suitable adjustment. If the bus voltage with the transformer is outside the range, the data processing system 202 may generate or cause generation of a control signal to adjust a tap the transformer to increase the bus voltage is the bus voltage is less than a lower voltage level limit of the range. For example, the data processing system 202 may generate or cause generation of a control signal to adjust a tap the transformer to increase the bus voltage by 1%, 5%, 10%, or other suitable adjustment. The data processing system 202 may slightly adjust the operation of one or more subsystems at each iteration of the method 370 such that overtime the subsystems trend toward operational compliance with the control objective ranges 222. Doing so gradually over two or more iterations of the method 370 may reduce a likelihood of transients being introduced into switching and control operations, where transients may reduce a reliability or accuracy of control operations and are generally desired to be reduced.

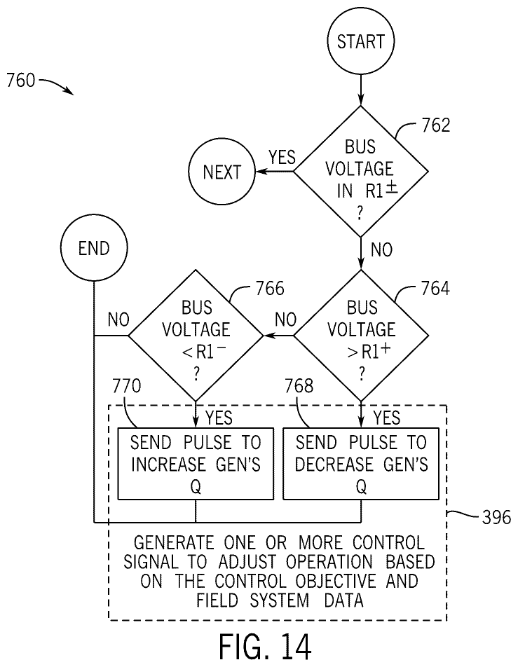

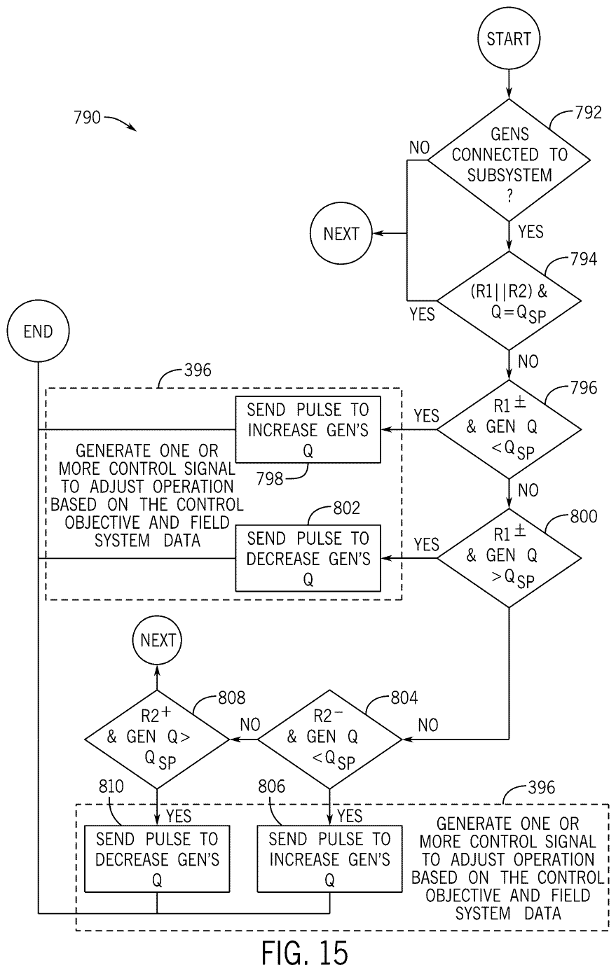

When the data processing system 202 determines that the bus voltage is within the range and thus that the voltage bus with transformer control objective is completed, in process block 384, the data processing system 202 may proceed to perform the next-in-priority control objective indicated by the first order. The data processing system 202 may control the subsystems based on the next-in-priority control objective by referencing the first order and the number and type of devices connected to the target subsystem to determine whether the next-in-priority control objective applies to the target subsystem. When it does apply, the data processing system 202 accesses and executes the instructions corresponding to the next-in-priority control objective. The data processing system 202 may do so for each subsequent control objective indicated in the first order. Here, in process block 384, the data processing system 202 may skip executing the voltage bus with generator control objective instructions (which may correspond to operations of FIG. 14). The data processing system 202 may skip these operations since these operations do not apply in this subsystem configuration. In process block 386, the data processing system 202 may execute the generator reactive power (Q) control objective instructions. In doing so, the data processing system 202 may perform at least some of the operations described relative to FIG. 15 herein.

In decision block 388, the data processing system 202 may determine whether the generator reactive power (Q) control objective is completed. For example, the data processing system 202 may determine whether reactive power (Q) of a respective generator is within a range of the control objective ranges 222, and thus the data processing system 202 may determine whether the generator reactive power (Q) control objective is completed. An example range may be described herein relative to FIG. 12 and/or FIG. 15.

When the data processing system 202 determines that the generator reactive power (Q) control objective is not completed, the data processing system 202 may proceed to process block 396. In process block 396, the data processing system 202 may generate one or more control signal to adjust an operation of the generator(s) of the target subsystem based on the generator reactive power (Q) control objective and the field system data 210.

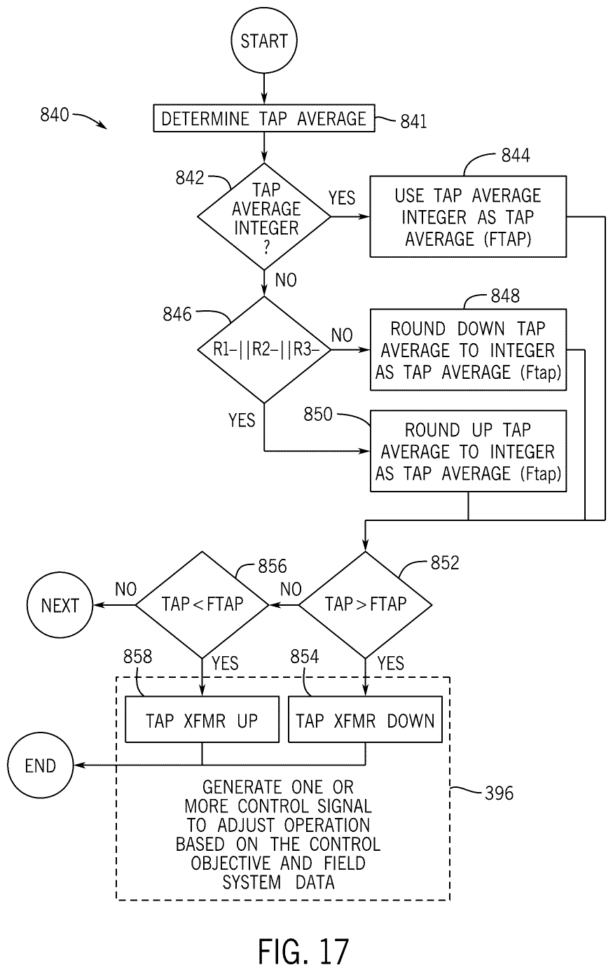

When the data processing system 202 determines that the generator reactive power (Q) control objective is completed, the data processing system 202 may proceed to process block 390. In process block 390, the data processing system 202 may execute the minimizing circulating current control objective instructions. In doing so, the data processing system 202 may perform at least some of the operations described relative to FIG. 17 herein.

In decision block 392, the data processing system 202 may determine whether the minimizing circulating current control objective is completed. For example, the data processing system 202 may determine whether a circulating current associated with two or more transformers has been minimized, and thus whether the minimizing circulating current control objective is completed. For example, the data processing system 202 may determine whether a circulating current associated with two or more transformers coupled in parallel has been minimized, and thus whether the minimizing circulating current control objective is completed. In some cases, a current may be deemed minimized when it is determined to be within a range of the control objective ranges 222. An example range may be described herein relative to FIG. 12 and/or FIG. 17.

When the data processing system 202 determines that the minimizing circulating current control objective is completed, the data processing system 202 may proceed to operations of process block 394. In process block 394, the data processing system 202 may generate a completion notification. The completion notification may cause an indication to be presented via the HMI to alert an operator to the ongoing performance of the monitoring and control operations of the method 370.

When the data processing system 202 determines that the minimizing circulating current control objective is not completed, the data processing system 202 may proceed to operations of process block 396. In process block 396, the data processing system 202 may generate one or more control signal to adjust an operation of one or more transformers of the target subsystem to minimize a circulating current based on the minimizing circulating current control objective and the field system data 210.

After operations of process block 396 and/or process block 394, the data processing system 202 may repeat the operations of the method 370 at process block 372, with receiving additional field system data 210 that represents an updated present operation of the electric power delivery system. In the updated present operation, one or more statuses of the subsystems or the devices may change, voltages, currents, or the like may change, operating frequencies, power delivered, Q delivered, or the like may change. In receiving new field system data 210, the data processing system 202 may repeat the operations of the method 370 on an ongoing basis responsive to receiving new field system data 210. For example, the data processing system 202 may adjust control signals generated at process block 396 in a future iteration to the new field system received over time.

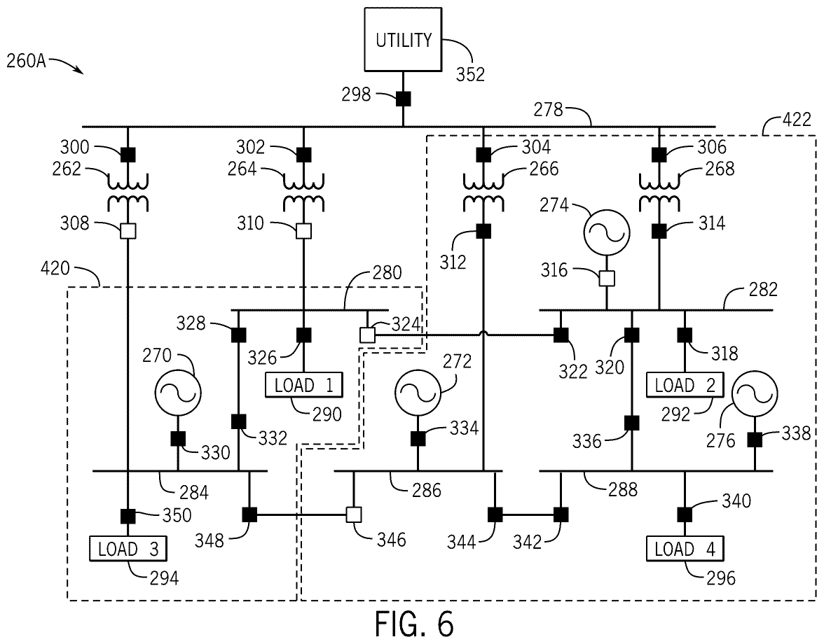

With this in mind, FIGS. 6-11B illustrate example changes that may occur over time in a power delivery system and/or different configurations of a power delivery system that may yield different control operation arrangements being used by the data processing system 202. The data processing system 202 may apply different combinations of control objective instructions to the different configurations. In doing so, the data processing system 202 may keep underlying control operations consistent between the different configurations to arrive at a plug-in-play type of control operation, where respective operations are applied as deemed applicable for that configuration. As such, descriptions of the process 370 made relative to FIG. 5 are relied upon here for FIGS. 6-11. For example, the process 370 is described relative to example ranges of the control objective ranges 222 and it should be understood that similar ranges of the control objective ranges 222 may be used to perform processes 370A, 370B, and 370C herein so specific reference to the control objective ranges 222 may be omitted.

Indeed, as an example, FIG. 6 illustrates an example of some changes that may occur over time, and how the changes cause changes in control algorithms implemented by the data processing system 202. FIG. 6 is a schematic diagram of an example of the electric power delivery system 260A, which may be an example of the electric power delivery system 260 of FIG. 4, interconnected with two subsystems, two transformers, and two generators, in accordance with an aspect of the present disclosure. Components illustrated in the schematic diagram of FIG. 6 correspond to the components illustrated in the schematic diagram of FIG. 4, with some of the components being disconnected from the busses. These components being disconnected from the bus may change control operations data processing system 202 performs relative to the electric power delivery system 260A when compared to those performed relative to the electric power delivery system 260.

For example, circuit breakers 308, 310, 324, 346 are disconnected (e.g., open). The circuit breakers 324, 346 being disconnected leads to the electric power delivery system 260A having two subsystems instead of one subsystem of the electric power delivery system 260 as illustrated in FIG. 4. First subsystem 420, as illustrated, is disconnected from the bus 278, and thus disconnected from the utility 352. Circuit breakers 308, 310 being disconnected or connected determine whether the first subsystem 420 has transformers 262, 264 or not. The generator 270 may supply power to the first subsystem 420 in isolation from second subsystem 422.

The second subsystem 422 may be connected to the bus 278 and thus connected to the utility 352 through the circuit breakers 304, 306, 312, 314 that are closed. The circuit breaker 316 is open, which disconnects the generator 274 from the second subsystem 422. The second subsystem 422 is connected to the transformers 266, 268 without being electrically supplied through the transformers 262, 264 in this configuration.

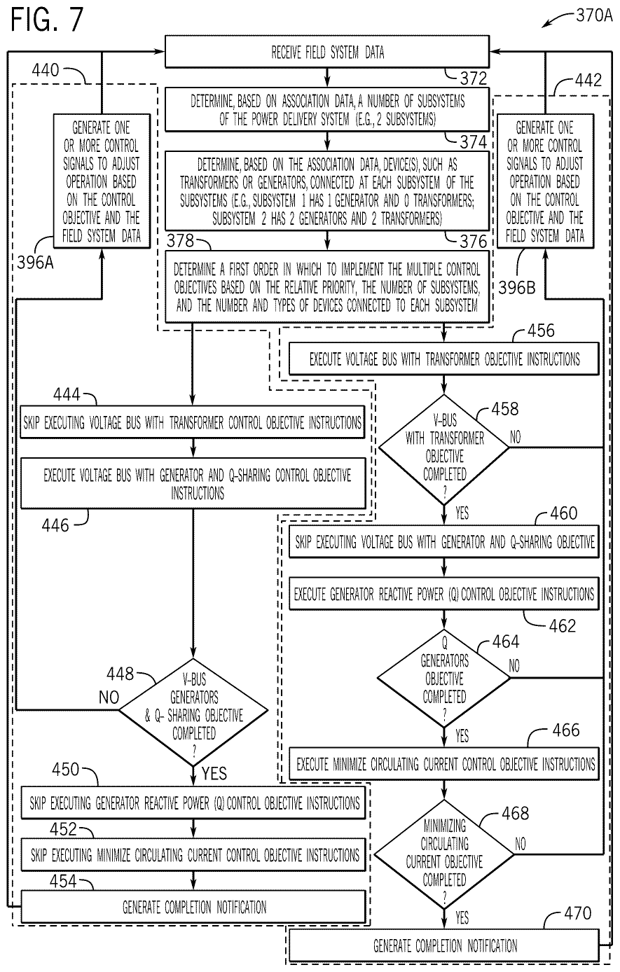

FIG. 7 is a flowchart of a method 370A for autonomous control of the electric power delivery system 260A of FIG. 6. Operations of the method 370A may be similar to operations of the method 370 and are applied to a two subsystem, two transformer, and three generator configuration of the electric power delivery system 260 (e.g., electric power delivery system 260A illustrated in FIG. 6). For ease of explanation and for the sake of brevity, descriptions of at least FIG. 7 are relied upon herein. Moreover, the method 370A is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 370A. In some embodiments, the method 370A may be implemented by executing instructions stored in a tangible, non-transitory, computer-readable medium, such as a memory, using the data processing system 202. For example, the method 370A may be performed at least in part by one or more software components, such as the control development software, one or more software applications of the IEDs 104, 106, 108, 115, and the like. While the method 370A is described using operations in a specific sequence, it should be understood that the present disclosure contemplates that the described operations may be performed in different sequences than the sequence illustrated, and certain described operations may be skipped or not performed altogether.

The data processing system 202 may perform the operations of FIG. 7 described herein based on one or more control objective ranges 222, similar to how described above relative to operations of FIG. 5. The control objective ranges 222 may be defined based on range regions (e.g., range regions illustrated in FIG. 12). In process blocks 372, 374, 376, 378, the data processing system 202 may perform similar operations as described earlier relative to the method 370 of FIG. 5. For example, in process block 372, the data processing system 202 may receive field system data 210 associated with a present operation of the electric power delivery system 260A.

In process block 374, the data processing system 202 may determine, based on the association data 212, a number of subsystems of the electric power delivery system 260A. The data processing system 202 may determine there are two subsystems 420, 422 in electric power delivery system 260A based on evaluating which portions of the electric power delivery system 260A are separated from each other through open circuit breakers. For example, the data processing system 202 may determine there are two subsystems 420 and 422 by comparing the open circuit breakers 308, 310, 316, 324, 346 to indications of electrical connections of the electric power delivery system 260A indicated in the association data 212.

In process block 376, the data processing system 202 may determine, based on the association data 212, device(s) (e.g., transformers, generators) connected at each of the two subsystems 420, 422. For example, the data processing system 202 may determine that the subsystem 420 is connected to the generator 270 without being connected to the transformers 262, 264, 266, 268 and without being connected to the generators 272, 274, 276 (e.g., based on open circuit breakers 308, 310, 316, 324, 346). The data processing system 202 may determine that the subsystem 422 is connected to the generators 272, 276 without being connected to the generators 270, 274 based on determining that multiple circuit breakers 308, 310, 316, 324, 346 are open and comparing this determination to the association data 212 to identify which devices are affected by the circuit breakers 308, 310, 316, 324, 346 being open. The data processing system 202 may determine that the subsystem 422 is connected to the transformers 266, 268 and without being connected to the transformers 262, 264 based on determining that multiple circuit breakers 308, 310, 316, 324, 346 are open and comparing this determination to the association data 212 to identify which devices are affected by the circuit breakers 308, 310, 316, 324, 346 being open.

In process block 378, the data processing system 202 may determine a first order in which to implement the multiple control objectives (e.g., respective sets of instructions of the control objective instructions 218) based on the relative priority (e.g., the control objective priorities 220) and the number and types of devices connected to each subsystem 420, 422. The first order may be same as discussed earlier relative to process block 378 if the underlying electric power delivery system 260 may be the same, if the customer or operator of the electric power delivery system 260A is the same as the customer or operator of the electric power delivery system 260, or the like, such as if other conditions are present that may cause the data processing system 202 to prioritize the control objectives in the same order for both electric power delivery systems 260A, 260 despite being different electric power delivery systems or being operated by different operators. In following a priority, the data processing system 202 may apply the priority of the various control objectives to respectively control each of subsystems 420, 422. The priority of the various control objectives and whether to execute respective of the various control objectives, on a per-subsystem basis, may be indicated in the first order based on operations performed by the data processing system 202 at the process block 378.

In operations 440, the data processing system 202 may apply operations of method 370 to subsystem 420. In operations 442, the data processing system 202 may apply operations of method 370 to subsystem 422. The data processing system 202 may perform operations 440 and operations 442 at least partially at an overlapping time. Since operations 440 skips some operations that operations 442 performs, the first decision to execute or skip may be performed at the same time for each subsystem 420, 422, while subsequent decisions may be made at different times when the decision to skip spends less time or resources that performing the execute operation. For example, the operations 442 may take longer for the data processing system 202 to perform relative to the operations 440 as the operations 442 involve three execution operations and one skip operation and the operations 440 involve one execution operation and three skip operations.

In the operations 440, the data processing system 202 may skip or execute respective operations based on the first order. The data processing system 202 may perform a subset of the respective operations applicable to the subsystem 420 in the priority order indicated by the control objective priorities 220 based on processing the control objective priorities 220 the association data 212. The subset of the respective operations performed by the data processing system 202 relative to the subsystem 420 may include the data processing system 202 skipping executing the voltage bus with transformer control objective instructions (process block 444), the data processing system 202 executing the voltage bus with generator and reactive power (Q) power sharing control objective instructions (process block 446), and the data processing system 202 determining whether the voltage bus with generator and reactive power (Q) power sharing control objective is completed (decision block 448). When the data processing system 202 determines the voltage bus with generator and reactive power (Q) power sharing control objective is not completed (e.g., based on processing sensed values indicated in the field system data 210), the data processing system 202 may generate one or more control signals (process block 396A). The one or more control signals may be generated by the data processing system 202 to adjust operation of the subsystem 420 based on the control objective and the field system data 210. The data processing system 202 may determine the adjustment to be applied to present operational conditions of the subsystem 420 indicated through values of the field system data 210 to shift operation toward completing the voltage bus with generator and reactive power (Q) power sharing control objective. When the data processing system 202 determines voltage bus with generator and reactive power (Q) power sharing control objective is completed (e.g., based on processing sensed values indicated in the field system data 210), the data processing system 202 may skip execution of the generator reactive power (Q) control objective instructions (process block 450), may skip execution of the minimizing circulating current control objective instructions (process block 452), and may generate a completion notification (process block 454), which indicates the method 370A iteration for the subsystem 420 as completed.

In the operations 442, the data processing system 202 may skip or execute respective operations based on the first order. The data processing system 202 may perform a subset of the respective operations applicable to the subsystem 422 in the priority order indicated by the control objective priorities 220 based on processing the control objective priorities 220 the association data 212. The subset of the respective operations performed by the data processing system 202 relative to the subsystem 422 may include the data processing system 202 executing the voltage bus with transformer control objective instructions (process block 456), and the data processing system 202 determining whether the voltage bus with transformer control objective is completed (decision block 458). When the data processing system 202 determines the voltage bus with transformer control objective is not completed (e.g., based on processing sensed values indicated in the field system data 210), the data processing system 202 may generate one or more control signals (process block 396B). The one or more control signals may be generated by the data processing system 202 to adjust operation of the subsystem 422 based on the control objective and the field system data 210. The data processing system 202 may determine the adjustment to be applied to present operational conditions of the subsystem 422 indicated through values of the field system data 210 to shift operation toward completing the voltage bus with transformer control objective. When the data processing system 202 determines the voltage bus with transformer control objective is completed, the data processing system 202 may skip executing the voltage bus with generator and reactive power (Q) power sharing control objective instructions (process block 460). The data processing system 202 may execute the generator reactive power (Q) control objective instructions (process block 462) and determine whether the generator reactive power (Q) control objective is completed (decision block 464). When the data processing system 202 determines the generator reactive power (Q) control objective is not completed (e.g., based on processing sensed values indicated in the field system data 210), the data processing system 202 may generate one or more control signals (process block 396B). The one or more control signals may be generated by the data processing system 202 to adjust operation of the subsystem 422 based on the control objective and the field system data 210. The data processing system 202 may determine the adjustment to be applied to present operational conditions of the subsystem 422 indicated through values of the field system data 210 to shift operation toward completing determines the generator reactive power (Q) control objective. When the data processing system 202 determines the generator reactive power (Q) control objective is completed, the data processing system 202 may execute minimizing circulating current control objective instructions (process block 466) and may determine whether the minimizing circulating current control objective is completed (decision block 468). When the data processing system 202 determines the minimizing circulating current control objective is not completed (e.g., based on processing sensed values indicated in the field system data 210), the data processing system 202 may generate one or more control signals (process block 396B). The one or more control signals may be generated by the data processing system 202 to adjust operation of the subsystem 422 based on the control objective and the field system data 210. The data processing system 202 may determine the adjustment to be applied to present operational conditions of the subsystem 422 indicated through values of the field system data 210 to shift operation toward completing the minimizing circulating current control objective. When the data processing system 202 determines the minimizing circulating current control objective is completed, the data processing system 202 may generate a completion notification (process block 470), which indicates the method 370A iteration for the subsystem 422 as completed.

In some cases, feedback operations of the respective operations 440, 442 may provide feedback (e.g., in the form of control signals) to the subsystems 420, 422 at different times and the data processing system 202 may wait until both operations 440 and operations 442 are completed with a first iteration before advancing to perform a second iteration based on new field system data at process block 372. In some systems, the data processing system 202 may execute second control objective instructions (e.g., block 446) relative to the first subsystem 420 at a different time than skipping execution of the second control objective instructions relative to the second subsystem 422 (e.g., block 460) despite the data processing system 202 starting to perform operations of blocks 444, 456 at a same time. In some cases, the operations 440 may not be performed in lockstep with the operations 442 since these operations are performed relative to independent power systems and the data processing system 202 may be capable of running the subsystems together or in parallel at independent timing relative to each other. In some cases, the operations 440 may be performed in lockstep with the operations 442. For example, the data processing system 202 may wait to advance to perform operation of process block 452 until operations of process block 466 are able to be performed, for example, based on handshaking operations, signal exchange operations, or the like between different processing resources of the data processing system 202 that may be assigned portions of the parallel execution of the operations 440, 442. In some systems, the operations 440 may start at a same time as the operations 442, while completing at different times or without control as to the operations being performed in lockstep.

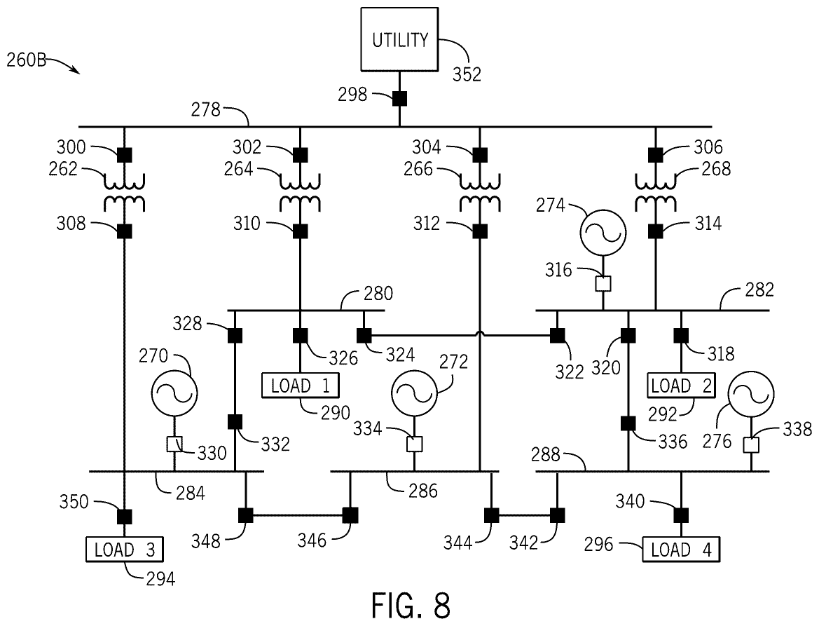

FIGS. 6-7 illustrate, as the electric power delivery system 260A, one example of a switch configuration of the electric power delivery system 260. Another example of a switch configuration is illustrated in FIG. 8.

FIG. 8 is a schematic diagram of an example of the electric power delivery system 260 of FIG. 4, as the electric power delivery system 260B, with one subsystem, four transformers, and zero generators connected. The electric power delivery system 260B, as illustrated, has open circuit breakers 316, 330, 334, 338 and closed circuit breakers 300, 302, 304, 306, 308, 310, 312, 314, 318, 320, 322, 324, 326, 328, 332, 336, 340, 342, 344, 346, 348, 350. The electric power delivery system 260B has one subsystem. The one subsystem is not connected through circuit breakers to the generators 270, 272, 274, 276. The one subsystem is connected through circuit breakers to the transformers 262, 264, 266, 268. Thus, the electric power delivery system 260B is illustrated in this configuration as having one subsystem with four transformers and zero generators connected.

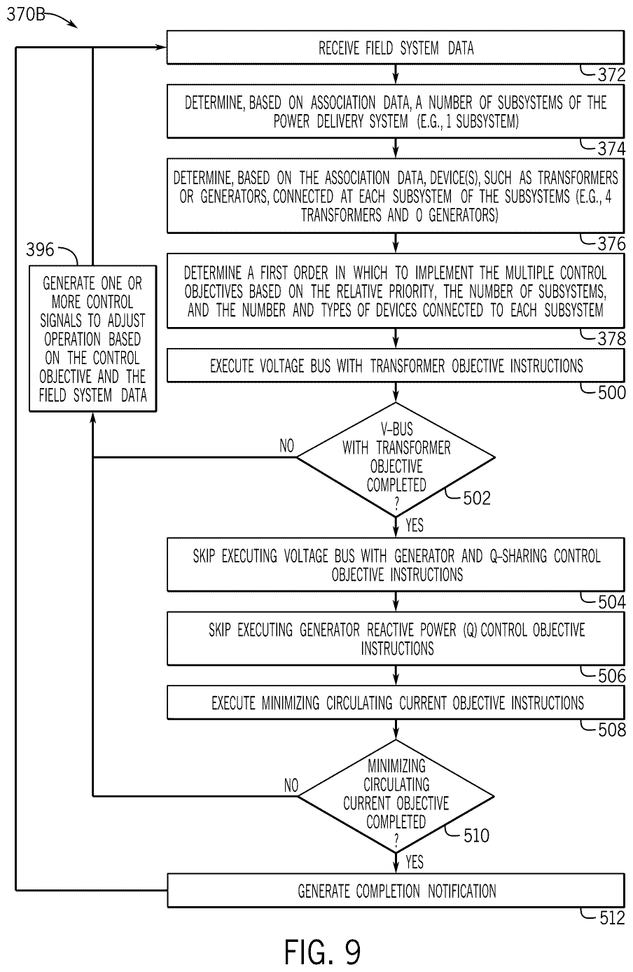

Based on this configuration, the data processing system 202 may change what control objective instructions are executed relative to the one subsystem. These operations are described further relative to FIG. 9.

FIG. 9 is a flowchart of a method 370B for autonomous control of the electric power delivery system 260B of FIG. 8. Operations of the method 370B are similar to operations of the method 370 as applied to a one subsystem, four transformer, and zero generator configuration of the electric power delivery system 260 (e.g., electric power delivery system 260B illustrated in FIG. 8). For ease of explanation and for the sake of brevity, descriptions of at least FIG. 7 are relied upon herein. Moreover, the method 370B is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 370B. In some embodiments, the method 370B may be implemented by executing instructions stored in a tangible, non-transitory, computer-readable medium, such as a memory, using the data processing system 202. For example, the method 370B may be performed at least in part by one or more software components, such as the control development software, one or more software applications of the IEDs 104, 106, 108, 115, and the like. While the method 370B is described using operations in a specific sequence, it should be understood that the present disclosure contemplates that the described operations may be performed in different sequences than the sequence illustrated, and certain described operations may be skipped or not performed altogether.

The data processing system 202 may perform the operations of FIG. 9 described herein based on one or more control objective ranges 222, similar to how described above relative to operations of FIG. 5. The control objective ranges 222 may be defined based on range regions (e.g., range regions illustrated in FIG. 12). In process blocks 372, 374, 376, 378, the data processing system 202 may perform similar operations as described earlier relative to the method 370 of FIG. 5. For example, in process block 372, the data processing system 202 may receive field system data 210 associated with a present operation of the electric power delivery system 260B.

In process block 374, the data processing system 202 may determine, based on the association data 212, a number of subsystems of the electric power delivery system 260B. The data processing system 202 may determine there is one subsystem in electric power delivery system 260B based on evaluating which portions of the electric power delivery system 260B are separated from each other through open circuit breakers. For example, the data processing system 202 may determine there is one subsystem by comparing the open circuit breakers 316, 330, 334, 338 to indications of electrical connections of the electric power delivery system 260B indicated in the association data 212.

In process block 376, the data processing system 202 may determine, based on the association data 212, device(s) (e.g., four transformers and zero generators) connected at the subsystem. For example, the data processing system 202 may determine that the subsystem is connected to the transformers 262, 264, 266, 268 without being connected to the generators 270, 272, 274, 276 (e.g., based on open circuit breakers 316, 330, 334, 338).

In process block 378, the data processing system 202 may determine a first order in which to implement the multiple control objectives (e.g., respective sets of instructions of the control objective instructions 218) based on the relative priority (e.g., the control objective priorities 220) and the number and types of devices connected to the subsystem. The first order may be same as discussed earlier relative to process block 378 of FIG. 5 if the underlying electric power delivery system 260 may be the same, if the customer or operator of the electric power delivery system 260B is the same as the customer or operator of the electric power delivery system 260, or the like, such as if other conditions are present that may cause the data processing system 202 to prioritize the control objectives in the same order for both electric power delivery systems 260B, 260 despite being different electric power delivery systems or being operated by different operators.

In following a priority, the data processing system 202 may apply the priority of the various control objectives to control the subsystem. The priority of the various control objectives and whether to execute respective of the various control objectives, on a per-subsystem basis, may be indicated in the first order based on operations performed by the data processing system 202 at the process block 378. For example, the operations of process blocks 500, 504, 506, and 508 may be skipped or executed based on the data processing system 202 applying the priority of the various control objectives and the configuration of the subsystem (e.g., configuration of the electric power delivery system 260B) in the control of the subsystem.

For example, the data processing system 202 may skip or execute respective operations based on the first order indicated at process block 378. The data processing system 202 may perform a subset of the respective operations applicable to the subsystem of the electric power delivery system 260B in the priority order indicated by the control objective priorities 220 based on processing the control objective priorities 220 the association data 212. The subset of the respective operations performed by the data processing system 202 relative to the subsystem of the electric power delivery system 260B may include the data processing system 202 executing the voltage bus with transformer control objective instructions (process block 500), and the data processing system 202 determining whether the voltage bus with transformer control objective is completed (decision block 502). For example, the operations of process block 500 may correspond to operations of the process block 380 as applied to the single subsystem configuration associated with the electric power delivery system 260B.

When the data processing system 202 determines the voltage bus with transformer control objective is not completed (e.g., based on processing sensed values indicated in the field system data 210), the data processing system 202 may generate one or more control signals (process block 396). The one or more control signals may adjust operation of the subsystem of the electric power delivery system 260B based on the control objective (e.g., here the voltage bus with transformer control objective) and the field system data 210 (e.g., the adjustment applied to the operation may be made based on present operational conditions of the subsystem of the electric power delivery system 260B indicated through values of the field system data 210).

When the data processing system 202 determines the voltage bus with transformer control objective is completed (e.g., based on processing sensed values indicated in the field system data 210), the data processing system 202 may skip executing the voltage bus with generator and reactive power (Q) power sharing control objective instructions (process block 504). For example, the operations of process block 504 may correspond to operations of the process block 384 as applied to the single subsystem configuration associated with the electric power delivery system 260B. The processor may skip execution of the generator reactive power (Q) control objective instructions (process block 506) and may execute the minimizing circulating current control objective instructions (process block 508). For example, the operations of process block 506 may correspond to operations of the process block 450 as applied to the single subsystem configuration associated with the electric power delivery system 260B. For example, the operations of process block 508 may correspond to operations of the process block 390 as applied to the single subsystem configuration associated with the electric power delivery system 260B.

The data processing system 202 may determine whether the minimizing circulating current control objective is completed (decision block 510). The operations of decision block 510 may correspond to operations of the decision block 392. When the data processing system 202 determines the minimizing circulating current control objective is not completed (e.g., based on processing sensed values indicated in the field system data 210), the data processing system 202 may generate one or more control signals (process block 396). The one or more control signals may be generated by the data processing system 202 to adjust operation of the subsystem based on the control objective and the field system data 210. The data processing system 202 may determine the adjustment to be applied to present operational conditions of the subsystem indicated through values of the field system data 210 to shift operation toward completing the minimizing circulating current control objective. When the data processing system 202 determines the minimizing circulating current control objective is completed (e.g., based on processing sensed values indicated in the field system data 210), the data processing system 202 may generate a completion notification (process block 512). The complete notification may indicate the method 370B iteration for the subsystem of the electric power delivery system 260B as completed. The operations of process block 512 may correspond to operations of process block 394. The completion notification may cause an indication to be presented via the HMI to alert an operator to the ongoing performance of the monitoring and control operations of the method 370.

FIGS. 10-11B illustrate a third example configuration of the electric power delivery system 260 of FIG. 4. The third example configuration may include five subsystems connected to one or more of four transformers and/or one or more of four generators. Accordingly, operations illustrated in the method of FIGS. 11A and 11B may be performed by the data processing system 202 tailoring the operations of the method 370 to the third example configuration illustrated in FIG. 10. Descriptions from above are relied upon herein for the sake of concise disclosure.

Indeed, FIG. 10 is a schematic diagram of an example of the electric power delivery system 260 of FIG. 4, electric power delivery system 260C. The electric power delivery system 260 may include circuit breakers 312, 320, 322, 324, 328, 330, 332, 336, 342, 344, 346, 348 in an open state. The electric power delivery system 260 may include the circuit breakers 300, 302, 304, 306, 308, 310, 314, 316, 318, 326, 334, 338, 340, 350 in a closed state. The electric power delivery system 260C includes five subsystems 550, 552, 554, 556, 558 connected to three transformers 262, 264, 268, and three generators 272, 274, 276. The subsystem 550 is connected to the transformer 262. The subsystem 552 is connected to the transformer 264. The subsystem 554 is connected to the generator 272. The subsystem 556 is connected to the transformer 268 and the generator 274. The subsystem 558 is connected to the generator 276. The subsystems 550, 552, 556 are respectively supplied from the utility bus 278 and are respectively separated from each other subsystems. The subsystems 554, 558 are respectively separated from the utility bus 278 and are respectively separated from the other subsystems.

When applying the operations of method 370 to subsystem 550 of the electric power delivery system 260C (e.g., operations 570 of FIGS. 11A and 11B), the data processing system 202 may determine to skip or execute respective control objective instructions for the subsystem 550. Here, the data processing system 202 may determine to execute instructions for the voltage bus with transformer control objective (based on there being at least one transformer coupled to the subsystem 550, transformer 262), to skip execution of instructions for the voltage bus with generator and reactive power (Q) sharing control objective (based on there not being a generator coupled to the subsystem 550), to skip execution of instructions for the generator reactive power (Q) control objective (based on there not being both a generator and a transformer coupled to the subsystem 550), and to skip execution of instructions for the minimizing circulating current control objective (based on there not being at least two transformers coupled to the subsystem 550).

When applying the operations of method 370 to subsystem 552 of the electric power delivery system 260C (e.g., operations 572 of FIGS. 11A and 11B), the data processing system 202 may execute similar instructions for the subsystems 552 as the subsystem 550 since both are connected to a single transformer (e.g., transformer 264 for the subsystem 552). The data processing system 202 may generate control signals to implement an adjustment to the subsystem 552 based on a present operation of the subsystem 552. The data processing system 202 may consider the adjustment to the subsystem 552 separately from adjustments applied to the subsystem 550 based on how the subsystems 550, 552 are separate.

When applying the operations of method 370 to subsystem 554 of the electric power delivery system 260C (e.g., operations 574 of FIGS. 11A and 11B), the data processing system 202 may determine to skip or execute respective control objective instructions for the subsystem 554. Here, the data processing system 202 may determine to skip execution of instructions for the voltage bus with transformer control objective (based on there not being at least one transformer coupled to the subsystem 554), to execute instructions for the voltage bus with generator and reactive power (Q) sharing control objective (based on the generator 276 being connected to the subsystem 554 without any transformers), to skip execution of instructions for the generator reactive power (Q) control objective (based on there not being at least one transformer coupled to the subsystem 554), and to skip execution of instructions for the minimizing circulating current control objective (based on there not being at least two transformers coupled to the subsystem 554).

When applying the operations of method 370 to subsystem 556 of the electric power delivery system 260C (e.g., operations 576 of FIGS. 11A and 11B), the data processing system 202 may determine to skip or execute respective control objective instructions for the subsystem 556. Here, the data processing system 202 may determine to execute instructions for the voltage bus with transformer control objective (based on there being at least one transformer coupled to the subsystem 556), to skip execution of instructions for the voltage bus with generator and reactive power (Q) sharing control objective (based on there not being a generator coupled without a transformer being coupled to the subsystem 556), to execute instructions for the generator reactive power (Q) control objective (based on both the generator 272 and the transformer 268 both being coupled to the subsystem 556), and to skip execution of instructions for the minimizing circulating current control objective (based on there not being at least two transformers coupled to the subsystem 556).

When applying the operations of method 370 to subsystem 558 of the electric power delivery system 260C (e.g., operations 578 of FIGS. 11A and 11B), the data processing system 202 may determine to skip or execute respective control objective instructions for the subsystem 558. Here, the data processing system 202 may determine to skip execution of instructions for the voltage bus with transformer control objective (based on there not being at least one transformer coupled to the subsystem 558), to perform the voltage bus with generator and reactive power (Q) sharing control objective (based on the generator 276 being connected to the subsystem 558), to skip execution of instructions for the generator reactive power (Q) control objective (based on there not being at least one transformer coupled to the subsystem 558), and to skip execution of instructions for the minimizing circulating current control objective (based on there not being at least two transformers coupled to the subsystem 558).

FIGS. 11A and 11B are a flowchart of a method 370C for autonomous control of the electric power delivery system 260C of FIG. 10. Operations of the method 370C are similar to operations of the method 370 as applied to a five subsystem, three transformer, and three generator configuration of the electric power delivery system 260 (e.g., electric power delivery system 260C illustrated in FIG. 10). For ease of explanation and for the sake of brevity, descriptions of at least FIG. 7 are relied upon herein. Moreover, the method 370C is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 370C. In some embodiments, the method 370C may be implemented by executing instructions stored in a tangible, non-transitory, computer-readable medium, such as a memory, using the data processing system 202. For example, the method 370C may be performed at least in part by one or more software components, such as the control development software, one or more software applications of the IEDs 104, 106, 108, 115, and the like. While the method 370C is described using operations in a specific sequence, it should be understood that the present disclosure contemplates that the described operations may be performed in different sequences than the sequence illustrated, and certain described operations may be skipped or not performed altogether.

The data processing system 202 may perform the operations of FIGS. 11A and 11B described herein based on one or more control objective ranges 222, similar to how described above relative to operations of FIG. 5. The control objective ranges 222 may be defined based on range regions (e.g., range regions illustrated in FIG. 12). In process blocks 372, 374, 376, 378, the data processing system 202 may perform similar operations as described earlier relative to the method 370 of FIG. 5. For example, in process block 372, the data processing system 202 may receive field system data 210 associated with a present operation of the electric power delivery system 260C.

In process block 374, the data processing system 202 may determine, based on the association data 212, a number of subsystems of the electric power delivery system 260C. The data processing system 202 may determine there are five subsystems 550, 552, 554, 556, 558 in electric power delivery system 260C based on evaluating which portions of the electric power delivery system 260C are separated from each other through open circuit breakers. For example, the data processing system 202 may determine there are five subsystems 550, 552, 554, 556, 558 by comparing the open circuit breakers 312, 320, 322, 324, 328, 330, 332, 336, 342, 344, 346, 348 to indications of electrical connections of the electric power delivery system 260C indicated in the association data 212.

In process block 376, the data processing system 202 may determine, based on the association data 212, device(s) (e.g., transformers, generators) connected at each of the subsystems 550, 552, 554, 556, 558. For example, the data processing system 202 may determine that the subsystem 550 is connected to the transformer 262 without being connected to the transformers 264, 266, 268 and without being connected to the generators 270, 272, 274, 276 (e.g., based on open circuit breakers 312, 320, 322, 324, 328, 330, 332, 336, 342, 346, 348). The data processing system 202 may determine that the subsystem 552 is connected to the transformer 264 without being connected to the transformers 262, 266, 268 and without being connected to the generators 270, 272, 274, 276. The data processing system 202 may determine that the subsystem 554 is connected to the generator 272 and without being connected to the transformers 262, 264, 266, 268 and without being connected to the generators 270, 274, 276. The data processing system 202 may determine that the subsystem 556 is connected to the generator 274 and the transformer 268 without being connected to the transformers 262, 264, 266 and without being connected to the generators 270, 272, 276. The data processing system 202 may determine that the subsystem 558 is connected to the generator 276 without being connected to the transformers 262, 264, 266, 268 and without being connected to the generators 270, 272, 274.

In process block 378, the data processing system 202 may determine a first order in which to implement the multiple control objectives (e.g., respective sets of instructions of the control objective instructions 218) based on the relative priority (e.g., the control objective priorities 220) and the number and types of devices connected to each subsystem 550, 552, 554, 556, 558. The first order may be same as discussed earlier relative to process block 378 if the underlying electric power delivery system 260 may be the same, if the customer or operator of the electric power delivery system 260C is the same as the customer or operator of the electric power delivery system 260, or the like, such as if other conditions are present that may cause the data processing system 202 to prioritize the control objectives in the same order for both electric power delivery systems 260C, 260 despite being different electric power delivery systems or being operated by different operators. In following a priority, the data processing system 202 may apply the priority of the various control objectives to respectively control each of subsystems 550, 552, 554, 556, 558. The priority of the various control objectives and whether to execute respective of the various control objectives, on a per-subsystem basis, may be indicated in the first order based on operations performed by the data processing system 202 at the process block 378.

In operations 570, the data processing system 202 may apply operations of method 370 to subsystem 550. In operations 572, the data processing system 202 may apply operations of method 370 to subsystem 552. In operations 574, the data processing system 202 may apply operations of method 370 to subsystem 554. In operations 576, the data processing system 202 may apply operations of method 370 to subsystem 556. In operations 578, the data processing system 202 may apply operations of method 370 to subsystem 558. The data processing system 202 may perform operations 570, 572, 574, 576, 578 at least partially at an overlapping time. Since some of the operations 570, 572, 574, 576, 578 skips some operations that other of the operations 570, 572, 574, 576, 578 perform, the first decision to execute or skip may be performed at a same time for each subsystem 550, 552, 554, 556, 558, while subsequent decisions may be made at different times when the decision to skip spends less time or resources that performing the execute operation. For example, the operations 576 may take longer for the data processing system 202 to perform relative to the operations 570 as the operations 576 involve two execution operations and two skip operation and the operations 570 involve one execution operation and three skip operations.

In the operations 570, the data processing system 202 may skip or execute respective operations based on the first order. The data processing system 202 may perform a subset of the respective operations applicable to the subsystem 550 in the priority order indicated by the control objective priorities 220 based on processing the control objective priorities 220 the association data 212. The subset of the respective operations performed by the data processing system 202 relative to the subsystem 550 may include the data processing system 202 executing the instructions for the voltage bus with transformer control objective (process block 580) (e.g., based on the subsystem 550 being coupled to at least one transformer), and the data processing system 202 determining whether the voltage bus with transformer control objective is completed (decision block 582). When the data processing system 202 determines the voltage bus with transformer control objective is not completed (e.g., based on processing sensed values indicated in the field system data 210), the data processing system 202 may generate one or more control signals (process block 396). The one or more control signals may be generated by the data processing system 202 to adjust operation of the subsystem 550 based on the control objective and the field system data 210. The data processing system 202 may determine the adjustment to be applied to present operational conditions of the subsystem 550 indicated through values of the field system data 210 to shift operation toward completing the voltage bus with transformer control objective. When the data processing system 202 determines the voltage bus with transformer control objective is completed (e.g., based on processing sensed values indicated in the field system data 210), the data processing system 202 may proceed to skip execution of instructions for the voltage bus with generator and reactive power (Q) power sharing control objective instructions (process block 584). The data processing system 202 may proceed to skip execution of the generator reactive power (Q) control objective instructions (process block 586). The data processing system 202 may proceed to skip execution of the minimizing circulating current control objective instructions (process block 588). The data processing system 202 may proceed to generate a completion notification (process block 590), which indicates the method 370C iteration for the subsystem 550 as completed.

In the operations 572, the data processing system 202 may skip or execute respective operations based on the first order. The data processing system 202 may perform a subset of the respective operations applicable to the subsystem 552 in the priority order indicated by the control objective priorities 220 based on processing the control objective priorities 220 the association data 212. Since both subsystems 550, 552 are coupled to respective transformers without being coupled to respective generators, the operations performed in operations 572 may correspond to operations performed in the operations 570 so descriptions are relied upon and not repeated herein.

In the operations 574, the data processing system 202 may skip or execute respective operations based on the first order. The data processing system 202 may perform a subset of the respective operations applicable to the subsystem 554 in the priority order indicated by the control objective priorities 220 based on processing the control objective priorities 220 the association data 212. The subset of the respective operations performed by the data processing system 202 relative to the subsystem 554 may include the data processing system 202 skipping the execution of the instructions for the voltage bus with transformer control objective (process block 604) (e.g., based on the subsystem 554 not being coupled to at least one transformer), and proceeding to execute the instructions for the voltage bus with generator and reactive power (Q) power sharing control objective instructions (process block 606). The data processing system 202 may determine whether the voltage bus with generator and reactive power (Q) power sharing control objective is completed (decision block 608). When the data processing system 202 determines the voltage bus with generator and reactive power (Q) power sharing control objective is not completed (e.g., based on processing sensed values indicated in the field system data 210), the data processing system 202 may generate one or more control signals (process block 396). The one or more control signals may be generated by the data processing system 202 to adjust operation of the subsystem 554 based on the control objective and the field system data 210. The data processing system 202 may determine the adjustment to be applied to present operational conditions of the subsystem 554 indicated through values of the field system data 210 to shift operation toward completing the voltage bus with generator and reactive power (Q) power sharing control objective. When the data processing system 202 determines the voltage bus with generator and reactive power (Q) power sharing control objective is completed (e.g., based on processing sensed values indicated in the field system data 210), the data processing system 202 may proceed to skip execution of the generator reactive power (Q) control objective instructions (process block 610) based on subsystem 554 being coupled to one generator without any transformers. The data processing system 202 may proceed to skip execution of the minimizing circulating current control objective instructions (process block 612) based on the subsystem 554 being coupled to one generator without two or more transformers. The data processing system 202 may proceed to generate a completion notification (process block 614), which indicates the method 370C iteration for the subsystem 554 as completed.

In the operations 576, the data processing system 202 may skip or execute respective operations based on the first order. The data processing system 202 may perform a subset of the respective operations applicable to the subsystem 556 in the priority order indicated by the control objective priorities 220 based on processing the control objective priorities 220 the association data 212. The subset of the respective operations performed by the data processing system 202 relative to the subsystem 556 may include the data processing system 202 executing of the instructions for the voltage bus with transformer control objective (process block 616) (e.g., based on the subsystem 556 being coupled to at least one transformer). The data processing system 202 may determine whether the voltage bus with transformer control objective is completed (decision block 618). When the data processing system 202 determines the voltage bus with transformer control objective is not completed (e.g., based on processing sensed values indicated in the field system data 210), the data processing system 202 may generate one or more control signals (process block 396). The one or more control signals may be generated by the data processing system 202 to adjust operation of the subsystem 556 based on the control objective and the field system data 210. The data processing system 202 may determine the adjustment to be applied to present operational conditions of the subsystem 556 indicated through values of the field system data 210 to shift operation toward completing the voltage bus with transformer control objective. When the data processing system 202 determines the voltage bus with transformer control objective is completed (e.g., based on processing sensed values indicated in the field system data 210), the data processing system 202 may proceed to skip execution of instructions for the voltage bus with generator and reactive power (Q) power sharing control objective (process block 620) based on subsystem 556 being coupled to one generator and one transformer. The data processing system 202 may proceed to execute the instructions for the generator reactive power (Q) control objective (process block 622) based on the subsystem 556 being coupled to both a generator and a transformer. The data processing system 202 may determine whether the generator reactive power (Q) control objective is completed (decision block 624). When the data processing system 202 determines the generator reactive power (Q) control objective is not completed (e.g., based on processing sensed values indicated in the field system data 210), the data processing system 202 may generate one or more control signals (process block 396). The one or more control signals may be generated by the data processing system 202 to adjust operation of the subsystem 556 based on the control objective and the field system data 210. The data processing system 202 may determine the adjustment to be applied to present operational conditions of the subsystem 556 indicated through values of the field system data 210 to shift operation toward completing the generator reactive power (Q) control objective. When the data processing system 202 determines the generator reactive power (Q) control objective is completed (e.g., based on processing sensed values indicated in the field system data 210), the data processing system 202 may skip execution of the instructions for the minimizing circulating current control objective (process block 626) based on the subsystem 556 being coupled to one transformer without two or more transformers. The data processing system 202 may generate a completion notification (process block 628), which indicates the method 370C iteration for the subsystem 556 as completed.

In the operations 578, the data processing system 202 may skip or execute respective operations based on the first order. The data processing system 202 may perform a subset of the respective operations applicable to the subsystem 558 in the priority order indicated by the control objective priorities 220 based on processing the control objective priorities 220 the association data 212. The subset of the respective operations performed by the data processing system 202 relative to the subsystem 558 may include the data processing system 202 skipping the execution of the instructions for the voltage bus with transformer control objective (process block 630) (e.g., based on the subsystem 558 not being coupled to at least one transformer). The data processing system 202 may execute instructions for the voltage bus with generator and reactive power (Q) power sharing control objective (process block 632). The data processing system 202 may determine whether the voltage bus with generator and reactive power (Q) power sharing control objective is completed (decision block 634). When the data processing system 202 determines the voltage bus with generator and reactive power (Q) power sharing control objective is not completed (e.g., based on processing sensed values indicated in the field system data 210), the data processing system 202 may generate one or more control signals (process block 396). The one or more control signals may be generated by the data processing system 202 to adjust operation of the subsystem 558 based on the control objective and the field system data 210. The data processing system 202 may determine the adjustment to be applied to present operational conditions of the subsystem 558 indicated through values of the field system data 210 to shift operation toward completing the voltage bus with generator and reactive power (Q) power sharing control objective. When the data processing system 202 determines the voltage bus with generator and reactive power (Q) power sharing control objective is completed (e.g., based on processing sensed values indicated in the field system data 210) (decision block 634), the data processing system 202 may skip execution of the instructions for the generator reactive power (Q) control objective (process block 636) based on subsystem 558 being coupled to one generator without being coupled to at least one transformer. The data processing system 202 may skip execution of the instructions for the minimizing circulating current control objective (process block 638) based on the subsystem 556 being coupled to one generator without being coupled to two or more transformers. The data processing system 202 may generate a completion notification (process block 640), which indicates the method 370C iteration for the subsystem 558 as completed.

In some cases, feedback operations of the respective operations 570, 572, 574, 576, 578 may provide feedback (e.g., in the form of control signals) to the subsystems 550, 552, 554, 556, 558 at different times and the data processing system 202 may wait until each of operations 570, 572, 574, 576, 578 are completed with a first iteration before advancing to perform a second iteration based on new field system data at process block 372. In some systems, the data processing system 202 may execute second control objective instructions relative to the first subsystem 550 at a different time than skipping execution of the second control objective instructions relative to the second subsystem 552 despite the data processing system 202 starting to perform operations of blocks 580, 592, 604, 616, 630 at a same time. In some cases, one or more of the operations 570, 572, 574, 576, 578 may not be performed in lockstep with one or more of the operations 570, 572, 574, 576, 578 since these operations are performed relative to independent power systems and the data processing system 202 may be capable of running the subsystems together or in parallel at independent timing relative to each other. In some cases, one or more of the operations 570, 572, 574, 576, 578 may be performed in lockstep with one or more other of the operations 570, 572, 574, 576, 578. For example, the data processing system 202 may wait to advance to perform operation of process block 586 until operations of process block 622 are able to be performed, for example, based on handshaking operations, signal exchange operations, or the like between different processing resources of the data processing system 202 that may be assigned portions of the parallel execution of the operations 570, 576 in this example. In some systems, the operations 570, 572, 574, 576, 578 may start at a same time, while completing at different times or without control as to the operations being performed in lockstep.

With the foregoing in mind, FIG. 12 is a diagrammatic representation 700 of one or more example control objective ranges. Control objective ranges may be used by the data processing system 202 to control operations of various subsystems described herein, such as relative to the process 370, the process 370A, the process 370B, and/or the process 370C. For example, the examples illustrated in the diagrammatic representation 700 may be examples of the control objective ranges 222. An example of a voltage range definition as a control objective range 222 is illustrated. However, it should be understood that any suitable parameter described herein may be associated with respective control objective ranges defined based on range regions.

The data processing system 202 may perform the operations described herein based on one or more control objective ranges 222. The control objective ranges 222 may be defined based on range regions, such as range regions 702A, 702B, 704A, 704B, 706A, 706B.

The voltage ranges may be associated with a setpoint at which the data processing system 202 is to target operation of a respective subsystem over time. The setpoint may correspond to a midpoint between a third setpoint upper limit and a third setpoint lower limit.

The range region 702A may be defined as between a third setpoint upper limit and a second setpoint upper limit, where the third setpoint upper limit may be greater in value than the second setpoint upper limit. The range region 702B may be defined as between a third setpoint lower limit and a second setpoint lower limit, where the second setpoint lower limit may be greater in value than the third setpoint lower limit.

The range region 704A may be defined as between the second setpoint upper limit and a first setpoint upper limit, where the second setpoint upper limit may be greater in value than the first setpoint upper limit. The range region 704B may be defined as between the second setpoint lower limit and a first setpoint lower limit, where the first setpoint lower limit may be greater in value than the second setpoint lower limit.

The range region 706A may be defined as between the first setpoint upper limit and a setpoint, where the first setpoint upper limit may be greater in value than the setpoint. The range region 706B may be defined as between the setpoint and the first setpoint lower limit, where the setpoint may be greater in value than the first setpoint lower limit.

The second setpoint lower limit may correspond to a voltage level, which may represent a lower deadband large negative percent deviation from the setpoint. The second setpoint upper limit may correspond to a voltage level, which may represent an upper deadband large percent deviation from the setpoint. A difference in voltage between the second setpoint upper limit and a third setpoint upper limit may correspond to a range region 702A. A difference in voltage between the second setpoint lower limit and a third setpoint lower limit may correspond to a range region 702B.

The first setpoint lower limit may correspond to a voltage level, which may represent a lower deadband small negative percent deviation from the setpoint. The first setpoint upper limit may correspond to a voltage level, which may represent an upper deadband small percent deviation from the setpoint. The difference in voltage between the second setpoint upper limit and the first setpoint upper limit may correspond to a range region 704A. A difference in voltage between the second setpoint lower limit and the first setpoint lower limit may correspond to a range region 704B. A difference in voltage between the first setpoint upper limit and the setpoint may correspond to a range region 706A. A difference in voltage between the first setpoint lower limit and the setpoint may correspond to a range region 706B.

The data processing system 202 may control operations of the subsystems to align with the setpoint, which also include permissive nominal deviation from the setpoint (e.g., +/−0.5%, 0.7%, 1% or the like). In some cases, this may be difficult to balance among each control objective for the subsystem and for other subsystems. Thus, the data processing system 202 may control operations of the subsystems to align with a range associated with the setpoint. For example, the data processing system 202 may control operations of the subsystems to cause a sensed voltage to fall within the range regions 706 or between the first setpoint upper limit (R1+) and the first setpoint lower limit (R1−) (e.g., R1−<sensed voltage<R1+). In some systems, the data processing system 202 may permit the operations to cause the sensed voltage to fall within the range regions 704 (which include the range regions 706) or in other words fall within the first setpoint limits with the additional condition to not fall outside the second setpoint limits (e.g., R2−<sensed voltage<R2+). Doing so may enable greater flexibility in controlling operations across each of the subsystems such that the operational setpoints and control objectives may be met in each subsystem. The data processing system 202 may adjust operations to avoid the sensed voltage falling within the range regions 702 or outside the second setpoint limits (e.g., sensed voltage >R2+ or sensed voltage <R2−).

Different subsystems may be associated with different setpoints. Accordingly, the data processing system 202 may access the different setpoints, and corresponding different range regions 702, 704, 706 in memory 204 when performing control operations discussed herein.

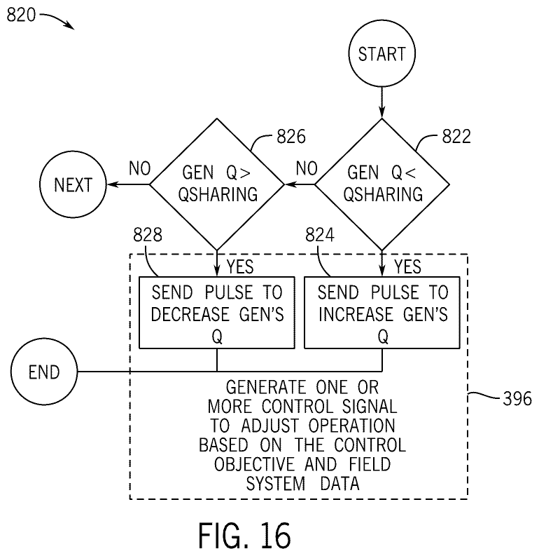

Different control objectives are described herein. FIGS. 13-17 illustrate example operations associated with the control objectives. FIG. 13 may illustrate example operations that the data processing system 202 may perform in response to executing instructions for the voltage bus with transformer control objective. FIG. 14 may illustrate example operations that the data processing system 202 may perform in response to executing instructions for the voltage bus with generator and reactive power (Q) power sharing control objective. FIG. 15 may illustrate example operations that the data processing system 202 may perform in response to executing instructions for the generator Q power control objective. FIG. 16 may illustrate example operations that the data processing system 202 may perform in response to executing instructions for a generator reactive power (Q) sharing control objective, which may be apply when two or more generators are coupled in the same subsystem. FIG. 17 may illustrate example operations that the data processing system 202 may perform in response to executing instructions for the minimizing circulating current control objective, where tap equalization is an example of minimizing circulating current based on average tap determinations.

Elaborating now on example control objectives, FIG. 13 is a flowchart of a method for transformer tap control for bus voltage control of the electric power delivery system of FIG. 1 associated with a first example control objective instruction. The method 720 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 720. In some embodiments, the method 720 may be implemented by executing instructions stored in a tangible, non-transitory, computer-readable medium, such as a memory, using the data processing system 202. For example, the method 720 may be performed at least in part by one or more software components, such as the control development software, one or more software applications of the IEDs 104, 106, 108, 115, and the like. While the method 720 is described using operations in a specific sequence, it should be understood that the present disclosure contemplates that the described operations may be performed in different sequences than the sequence illustrated, and certain described operations may be skipped or not performed altogether.

Operations of FIG. 13 may be an example of bus voltage control operations using transformers without any generators. Indeed, transformers may automatically control, via OLTCs, a tap position up or down (e.g., adjust a tap setting by increasing or decreasing the tap setting that the transformer generates signals based on). The position of the taps on windings of the transformers may adjust a voltage and/or current output from the transformer. The OLTC may do so to minimize the amount of current circulating through the subsystem. The data processing system 202 may instruct the OLTCs to change the tap position up or down to implement an adjustment to maintain a downstream bus voltage as within a relatively small deadband around the nominal bus voltage (e.g., setpoint parameter), where the relatively small deadband corresponds to range region 706 (e.g., R1^{±}). This control objective uses at least one transformer connected to the subsystem and no generators connected to the same subsystem. In some cases, this control objective may be used to control a subsystem with at least one transformer connected to the subsystem, where a generator may be directly connected to a same bus as the transformer but the generator cannot be run in a voltage mode. In some cases, this control objective may be used to control a subsystem with at least one transformer connected to the subsystem, where a generator is directly run to a same transformer bus with a power factor mode, a voltage droop mode, and a reactive power (Q) mode. In some cases, this control objective may be used to control a subsystem with at least one transformer connected to the subsystem, where a generator may be connected to the transformer bus through a generator step up (GSU) transformer with any more of operation.

In decision block 722, the data processing system 202 may determine whether a bus voltage of the target subsystem is within range region 706 (e.g., R1^{±}). If it is, the data processing system 202 may determine that the voltage bus with transformer control objective is completed and may proceed to a next operation (e.g., execute or skip execution of instructions for a next-in-priority control objective). If it is outside the range region 706, the data processing system 202 may proceed to decision block 724.

In decision block 724, the data processing system 202 may determine whether any generators are connected to the target subsystem. If there are, the data processing system 202 proceeds to decision block 726. If there are not, the data processing system 202 proceeds to decision block 732.

In decision block 726, the data processing system 202 may determine whether the bus voltage of the target subsystem is in the range region 702A or is in the range region 702B (e.g., in R3+∥in R3−). To do so, the data processing system 202 may determine whether the bus voltage is greater than the second setpoint upper limit or less than the second setpoint lower limit. If the bus voltage is in the range region 702A or is in the range region 702B, the data processing system 202 may, in process block 740, generate one or more control signals to adjust a tap of a target transformer coupled to the target subsystem to bring the bus voltage to the range region 706 (e.g., R1^{±}). After doing so, the data processing system 202 may end the iteration via receiving new field system data (e.g., at process block 372 or the like). If the bus voltage is not in the range region 702A or is not in the range region 702B, the data processing system 202 may proceed to decision block 728.

In decision block 728, the data processing system 202 may determine whether the bus voltage of the target subsystem is within the range region 704B (R2−) and the reactive power (Q) of the generator is greater than a setpoint of reactive power (Qₛₚ). The setpoint of reactive power (Qₛₚ) may be defined with the control objective ranges 222 for the target subsystem or the generator of the target subsystem (which may enable the data processing system 202 to apply a same setpoint when the generator is coupled in a different subsystem). If the bus voltage is within the range region 704B (R2−) and the reactive power (Q) of the generator is greater than a setpoint of reactive power (Qₛₚ), the data processing system 202 may, in process block 742, generate one or more control signals to adjust a tap of one or more transformers (e.g., each transformer) coupled to the target subsystem to bring the bus voltage to the range region 706 (e.g., R1^{±}). After doing so, the data processing system 202 may end the iteration via receiving new field system data (e.g., at process block 372 or the like). If the bus voltage is not within the range region 704B (R2−) or the reactive power (Q) of the generator is less than or equal to the setpoint of reactive power (Qₛₚ), the data processing system 202 may proceed to decision block 730.

In decision block 730, the data processing system 202 may determine whether the bus voltage of the target subsystem is within the range region 704A (R2+) and the reactive power (Q) of the generator is less than the setpoint of reactive power (Qₛₚ). If the bus voltage is within the range region 704A (R2+) and the reactive power (Q) of the generator is less than the setpoint of reactive power (Qₛₚ), the data processing system 202 may, in process block 744, generate one or more control signals to adjust a tap of one or more transformers (e.g., each transformer) coupled to the target subsystem to bring the bus voltage to the range region 706 (e.g., R1^{±}). After doing so, the data processing system 202 may end the iteration via receiving new field system data (e.g., at process block 372 or the like). If the bus voltage is not within the range region 704A (R2+) and the reactive power (Q) of the generator not less than the setpoint of reactive power (Qₛₚ), the data processing system 202 may determine that the voltage bus with transformer control objective is completed and may proceed to a next operation (e.g., execute or skip execution of instructions for a next-in-priority control objective).

Returning to decision block 724, the data processing system 202 may determine whether any generators are connected to the target subsystem, and, if there are not, the data processing system 202 may proceed to decision block 732 to determine whether the bus voltage of the target subsystem is greater than the range region 706A (R1+). To do so, the data processing system 202 may determine whether the bus voltage is greater than the first setpoint upper limit. If the bus voltage is greater than the range region 706A (R1+), the data processing system 202 may, in process block 738, one or more control signals to adjust a tap of one or more transformers (e.g., each transformer) coupled to the target subsystem to decrease the bus voltage to a voltage toward the setpoint but at least within the range region 706 (e.g., R1^{±}). If the bus voltage is less than the range region 706B (R1−), the data processing system 202 may, in process block 736, generate one or more control signals to adjust a tap of one or more transformers (e.g., each transformer) coupled to the target subsystem to increase the bus voltage to a voltage toward the setpoint but at least within the range region 706 (e.g., R1^{±}). After performing operations in process block 736, 738, or determining at decision block 734 that the bus voltage is less in the range region 706 (e.g., R1^{±}) (“No” branch operation), the data processing system 202 may end the iteration via receiving new field system data (e.g., at process block 372 or the like).

Operations of process blocks 736, 738, 740, 742, 744 are each an example of operations that may be associated with generating one or more control signals to adjust an operation of the subsystem (process block 396) based on the control objective and the field system data 210. In this example, values like the bus voltage and the generator reactive power (Q) may be indicated in the field system data 210.

Continuing on to describe another example control objective, FIG. 14 is a flowchart of a method 760 for generator excitation control for voltage control of the electric power delivery system of FIG. 1 associated with a second example control objective instruction. The method 760 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 760. In some embodiments, the method 760 may be implemented by executing instructions stored in a tangible, non-transitory, computer-readable medium, such as a memory, using the data processing system 202. For example, the method 760 may be performed at least in part by one or more software components, such as the control development software, one or more software applications of the IEDs 104, 106, 108, 115, and the like. While the method 760 is described using operations in a specific sequence, it should be understood that the present disclosure contemplates that the described operations may be performed in different sequences than the sequence illustrated, and certain described operations may be skipped or not performed altogether.

Operations of FIG. 14 may be an example of bus voltage control and reactive power (Q) sharing operations using one or more generators without any transformers in a targeted subsystem. Indeed, When there are at least two generators in the targeted subsystem, the two or more generators are used to maintain the connected bus voltage to be within a relatively small deadband around the nominal bus voltage (e.g., setpoint parameter), where the relatively small deadband corresponds to range region 706 (e.g., R1^{±}). The two or more generators may share the reactive power (Q) load based on the total reactive power (Q) each generator may provide. The sharing of reactive power (Q) load may be controlled be within the deadband (e.g., range region 706, R1^{±}). When there is one generator in the targeted subsystem, the generator is used to maintain the connected bus voltage to be within a small deadband around the nominal bus voltage (e.g., setpoint parameter), where the relatively small deadband corresponds to range region 706 (e.g., R1^{±}). Similar operations may be performed by the data processing system 202 in both cases. That is, similar operations may apply when there is one generator having its connected bus voltage controlled relative to the range region 706 or when there are two generators having the shared reactive power (Q) load controlled relative to the range region 706.

In decision block 762, the data processing system 202 may determine whether a bus voltage is within range region 706 (e.g., R1^{±}). If it is, the data processing system 202 may determine that the voltage bus with generator and reactive power (Q) power sharing control objective is completed and may proceed to a next operation (e.g., execute or skip execution of instructions for a next-in-priority control objective). If it is outside the range region 706, the data processing system 202 may proceed to decision block 764.

In decision block 764, the data processing system 202 may determine whether the bus voltage is greater than the range region 706A (R1+). If the bus voltage is greater than the range region 706A (R1+), the data processing system 202 may, in process block 768, generate one or more control signals to adjust a voltage reference of one or more generators (e.g., each generator) coupled to the target subsystem to decrease a reactive power (Q) of a generator of the target subsystem toward a setpoint but at least within the range region 706 (e.g., R1^{±}). If the bus voltage is not greater than less than the range region 706A (R1+), the data processing system 202 may proceed to decision block 766.

In decision block 766, the data processing system 202 may determine whether the bus voltage is less than the range region 706B (R1−). If the bus voltage is less than the range region 706B (R1−), the data processing system 202 may, in process block 770, generate one or more control signals to adjust a voltage reference of one or more generators (e.g., each generator) coupled to the target subsystem to increase the reactive power (Q) of the generator toward the setpoint but at least within the range region 706 (e.g., R1^{±}). If the bus voltage is not less than the range region 706B (R1−). After performing operations in process block 768, 770, or determining at decision block 766 that the bus voltage is not less than the range region 706B (R1−) (e.g., the bus voltage is within the range region 706 (e.g., R1^{±}), the data processing system 202 may end the iteration via receiving new field system data (e.g., at process block 372 or the like).

Operations of process blocks 768, 770 are each an example of operations that may be associated with generating one or more control signals to adjust an operation of the subsystem (process block 396) based on the control objective and the field system data 210. In this example, values like the bus voltage and the generator reactive power (Q) may be indicated in the field system data 210.

It is noted that the above operations are described relative to controlling the bus voltage, which may be applied to the one generator example described above. In situations where the targeted subsystem includes two or more generators, the data processing system 202 may perform similar operations except that the operations performed may change a shared reactive power (Q) load based on the setpoint. Indeed, different target ranges may be referenced for the different situations where one generator is present in the subsystem or two or more generators are present in the subsystem.

Continuing on to describe another example control objective, FIG. 15 is a flowchart of a method for generator excitation control for reactive power (Q) control of the electric power delivery system of FIG. 1 associated with a third example control objective instruction. The method 790 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 790. In some embodiments, the method 790 may be implemented by executing instructions stored in a tangible, non-transitory, computer-readable medium, such as a memory, using the data processing system 202. For example, the method 790 may be performed at least in part by one or more software components, such as the control development software, one or more software applications of the IEDs 104, 106, 108, 115, and the like. While the method 790 is described using operations in a specific sequence, it should be understood that the present disclosure contemplates that the described operations may be performed in different sequences than the sequence illustrated, and certain described operations may be skipped or not performed altogether.

Operations of FIG. 15 may be an example of generator reactive power (Q) setpoint control using at least one transformer and at least one generator coupled to a target subsystem. Transformers may automatically control, via OLTCs, a tap position up or down (e.g., adjust a tap setting by increasing or decreasing the tap setting that the transformer generates signals based on), which may increase or decrease the reactive power (Q) provided by the generator to bring the setpoint closer to the reactive power (Q) target. Generators may fine tune the reactive power (Q) target by increased or decreased reactive power (Q) to be within a relatively small deadband around the reactive power (Q) target setpoint (e.g., setpoint parameter), where the relatively small deadband corresponds to range region 706 (e.g., R1^{±}).

In decision block 792, the data processing system 202 may determine whether a generator is connected to the target subsystem. If there are, the data processing system 202 proceeds to decision block 794. If there are not, the data processing system 202 may determine that the generator Q power control objective is completed and may proceed to a next operation (e.g., execute or skip execution of instructions for a next-in-priority control objective).

In decision block 794, the data processing system 202 may determine whether a bus voltage of the target subsystem is within the range region 706 (e.g., R1^{±}) or the range region 704 (e.g., R2^{±}) and whether the reactive power (Q) of the target generator is equal to a reactive power setpoint (Qₛₚ). If both conditions are met, the data processing system 202 may determine that the generator Q power control objective is completed and may proceed to a next operation (e.g., execute or skip execution of instructions for a next-in-priority control objective). If one of the conditions is not met, the data processing system 202 may proceed to decision block 796.

In decision block 796, the data processing system 202 may determine whether the bus voltage of the target subsystem is in the range region 706 (e.g., R1^{±}) and whether the reactive power (Q) of the target generator is less than a reactive power setpoint (Qₛₚ). When both conditions are met, the data processing system 202 may, in process block 798, generate one or more control signals (e.g., send pulse) to increase the reactive power (Q) output of the generator to bring the reactive power (Q) toward the reactive power setpoint (Qₛₚ) of the generator. After doing so, the data processing system 202 may end the iteration via receiving new field system data (e.g., at process block 372 or the like). If the bus voltage is outside the range region 706 (e.g., R1^{±}) or when the reactive power (Q) of the target generator is greater than or equal to the reactive power setpoint (Qₛₚ), the data processing system 202 may proceed to decision block 800.

In decision block 800, the data processing system 202 may determine whether the bus voltage of the target subsystem is in the range region 706 (e.g., R1^{±}) and whether the reactive power (Q) of the target generator is greater than the reactive power setpoint (Qₛₚ). When both conditions are met, the data processing system 202 may, in process block 802, generate one or more control signals (e.g., send pulse) to decrease the reactive power (Q) output of the generator to bring the reactive power (Q) toward the reactive power setpoint (Qₛₚ) of the generator. After doing so, the data processing system 202 may end the iteration via receiving new field system data (e.g., at process block 372 or the like). If the bus voltage is outside the range region 706 (e.g., R1^{±}) or when the reactive power (Q) of the target generator is equal to the reactive power setpoint (Qₛₚ), the data processing system 202 may proceed to decision block 804.

In decision block 804, the data processing system 202 may determine whether the bus voltage of the target subsystem is in the range region 704B (e.g., R2−) and whether the reactive power (Q) of the target generator is less than the reactive power setpoint (Qₛₚ). When both conditions are met, the data processing system 202 may, in process block 806, generate one or more control signals (e.g., send pulse) to increase the reactive power (Q) output of the generator to bring the reactive power (Q) toward the reactive power setpoint (Qₛₚ) of the generator. After doing so, the data processing system 202 may end the iteration via receiving new field system data (e.g., at process block 372 or the like). If the bus voltage is outside the range region 704B (e.g., R2−) or when the reactive power (Q) of the target generator is greater than or equal to the reactive power setpoint (Qₛₚ), the data processing system 202 may proceed to decision block 808.

In decision block 808, the data processing system 202 may determine whether the bus voltage of the target subsystem is in the range region 704A (e.g., R2+) and whether the reactive power (Q) of the target generator is greater than the reactive power setpoint (Qₛₚ). When both conditions are met, the data processing system 202 may, in process block 810, generate one or more control signals (e.g., send pulse) to decrease the reactive power (Q) output of the generator to bring the reactive power (Q) toward the reactive power setpoint (Qₛₚ) of the generator. After doing so, the data processing system 202 may end the iteration via receiving new field system data (e.g., at process block 372 or the like). If the bus voltage is outside the range region 704A (e.g., R2+) or when the reactive power (Q) of the target generator is equal to the reactive power setpoint (Qₛₚ), the data processing system 202 may determine that the generator Q power control objective is completed and may proceed to a next operation (e.g., execute or skip execution of instructions for a next-in-priority control objective).

Operations of process blocks 798, 802, 806, 810 are each an example of operations that may be associated with generating one or more control signals to adjust an operation of the subsystem (process block 396) based on the control objective and the field system data 210. In this example, values like the bus voltage and the generator reactive power (Q) may be indicated in the field system data 210.

Continuing on to describe another example control objective, FIG. 16 is a flowchart of a method for sharing generator excitation, enabling sharing the reactive power (Q) among one or more generators in a voltage control mode of the electric power delivery system of FIG. 1 associated with a fourth example control objective instruction. The method 820 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 820. In some embodiments, the method 820 may be implemented by executing instructions stored in a tangible, non-transitory, computer-readable medium, such as a memory, using the data processing system 202. For example, the method 820 may be performed at least in part by one or more software components, such as the control development software, one or more software applications of the IEDs 104, 106, 108, 115, and the like. While the method 820 is described using operations in a specific sequence, it should be understood that the present disclosure contemplates that the described operations may be performed in different sequences than the sequence illustrated, and certain described operations may be skipped or not performed altogether.

In decision block 822, the data processing system 202 may determine whether the reactive power (Q) of the target generator is less than a reactive power sharing parameter (Qsharing). The reactive power sharing parameter (Qsharing) may be received with the field system data 210. The reactive power sharing parameter (Qsharing) may be a setpoint saved with the control objective ranges 222. If the reactive power (Q) of the target generator is less than the reactive power sharing parameter (Qsharing), the data processing system 202 may generate one or more control signals (e.g., send pulse) to increase the reactive power (Q) output of the generator to bring the reactive power (Q) toward the reactive power sharing parameter (Qsharing). After doing so, the data processing system 202 may end the iteration via receiving new field system data (e.g., at process block 372 or the like). If the reactive power (Q) of the target generator is greater than or equal to the reactive power sharing parameter (Qsharing), the data processing system 202 may proceed to decision block 826.

In the decision block 826, the data processing system 202 may determine whether the reactive power (Q) of the target generator is greater than the reactive power sharing parameter (Qsharing). If the reactive power (Q) of the target generator is greater than the reactive power sharing parameter (Qsharing), the data processing system 202 may generate one or more control signals (e.g., send pulse) to decrease the reactive power (Q) output of the generator to bring the reactive power (Q) toward the reactive power sharing parameter (Qsharing). After doing so, the data processing system 202 may end the iteration via receiving new field system data (e.g., at process block 372 or the like). If the reactive power (Q) of the target generator is equal to the reactive power sharing parameter (Qsharing), the data processing system 202 may determine that the generator reactive power (Q) sharing control objective is completed and may proceed to a next operation (e.g., execute or skip execution of instructions for a next-in-priority control objective).

Operations of process blocks 824, 828 are each an example of operations that may be associated with generating one or more control signals to adjust an operation of the subsystem (process block 396) based on the control objective and the field system data 210. In this example, values like the generator reactive power (Q) may be indicated in the field system data 210.

Continuing on to describe another example control objective, FIG. 17 is a flowchart of a method for tap equalization control among one or more transformers of the electric power delivery system of FIG. 1 associated with a fifth example control objective instruction. The method 840 is described herein as performed by the data processing system 202 of the control system 200 based on executing the instructions 214. However, it should be understood that any suitable device (e.g., a controller) that may control components of the electric power delivery system 100, such as one or more processors (e.g., of the IEDs 104, 106, 108, 115), may perform the method 840. In some embodiments, the method 840 may be implemented by executing instructions stored in a tangible, non-transitory, computer-readable medium, such as a memory, using the data processing system 202. For example, the method 840 may be performed at least in part by one or more software components, such as the control development software, one or more software applications of the IEDs 104, 106, 108, 115, and the like. While the method 840 is described using operations in a specific sequence, it should be understood that the present disclosure contemplates that the described operations may be performed in different sequences than the sequence illustrated, and certain described operations may be skipped or not performed altogether.

In process block 841, the data processing system 202 may determine a tap average. Determining the tap average may involve identifying transformers of the subsystem, determining respective tap settings for the respective transformers, and averaging the tap settings to identify the tap average. In decision block 842, the data processing system 202 may determine whether the tap average is an integer value (e.g., has an integer data type). If the tap average is an integer value (or has an integer data type), the data processing system 202 may use the tap average integer value as the tap average (Ftap). If it does not, the data processing system 202 may proceed to decision block 846.

In decision block 846, the data processing system 202 may determine whether the tap average is within the range region 706B (e.g., R1−) or within the range region 704B (e.g., R2−). Here, the range regions 702, 704, 706 may indicate ranges of tap settings deemed permissible and impermissible for the target subsystem. Indeed, minimizing circulating current between transformers may involve equalizing transformer tap settings. Transformers may automatically control, via OLTCs, tap position up or down to minimize the amount of current circulating through the subsystem. When the transformers have near similar parameters (e.g., windings, operational characteristics, supply voltages, step sizes) per unit, minimizing circulating current may be achieved through equalizing transformer tap settings. A target subsystem may have at least 2 transformers connected to the subsystem to undergo this control objective.

If in the voltage of the subsystem is within the range region 706B (e.g., R1−), within the range region 704B (e.g., R2−), or within the range region 702B (e.g., R3−), the data processing system 202 may round up the tap average to a new highest integer and use that integer as the tap average (Ftap) (process block 850). Rounding up the tap average may involve setting the fraction to the nearest highest integer, such as setting a tap average of 2.9 to 3.0 or a tap average of 2.1 to 3.0. Thus, the data processing system 202 may use the highest value of the tap settings when each tap setting within the range regions 706B, 704B, 702B. If the voltage of the subsystem is within the range region 706A (e.g., R1+), the range region 704A(e.g., R2+), or within the range region 702A (e.g., R3+), the data processing system 202 may round down the tap average to a next lowest integer and use that integer as the tap average (Ftap) (process block 848). Rounding down the tap average may involve setting the fraction to the nearest lower integer, such as setting a tap average of 2.9 to 2.0 or a tap average of 2.1 to 2.0. Thus, the data processing system 202 may use the lowest value of the tap settings when each tap setting is within the range regions 706A, 704A, 702A. Using the highest value outside of the range regions 706A, 704A (e.g., ceiling tap average) or the lowest value inside the range regions 706A, 704A (e.g., floor tap average) as the tap average (Ftap) may reduce or eliminate a likelihood of the data processing system 202 making large adjustments through transformer tap control operations. After performing operations of process blocks 844, 848, or 850, the data processing system 202 may proceed to decision block 852.

In decision block 852, the data processing system 202 may determine whether a transformer tap setting for the target transformer in the subsystem is greater than the tap setting average value (Ftap). If it is, the data processing system 202 may, in process block 854, generate or cause generation of one or more control signals (e.g., send pulse) to decrease a tap of the transformer to bring the tap setting of the transformer toward a tap setpoint associated with the range region 706A (e.g., R1+). After doing so, the data processing system 202 may end the iteration via receiving new field system data (e.g., at process block 372 or the like). If transformer tap setting for the target transformer in the subsystem is less than or equal to the tap setting average value (Ftap), the data processing system 202 may proceed to decision block 856.

In decision block 856, the data processing system 202 may determine whether the transformer tap setting for the target transformer in the subsystem is less than the tap setting average value (Ftap). If it is, the data processing system 202 may, in process block 858, generate one or more control signals (e.g., send pulse) to increase the tap of the transformer to bring the tap setting of the transformer toward a tap setpoint associated with the range region 706A (e.g., R1+). After doing so, the data processing system 202 may end the iteration via receiving new field system data (e.g., at process block 372 or the like). If transformer tap setting for the target transformer in the subsystem is equal to the tap setting average value (Ftap), may determine that the minimizing circulating current control objective is completed and may proceed to a next operation (e.g., execute or skip execution of instructions for a next-in-priority control objective or generate a completion notification if each control objective has been considered).

Operations of process blocks 854, 858 are each an example of operations that may be associated with generating one or more control signals to adjust an operation of the subsystem (process block 396) based on the control objective and the field system data 210. In this example, values like tap settings of one or more transformers may be indicated in the field system data 210.

With the foregoing in mind, additional or alternative control objectives may be used by the data processing system 202. For example, the control objective data 216 may include data for a first additional control objective and/or a second additional control objective.

The first additional control objective may correspond to bus voltage control using one or more transformers and one or more generators coupled to a target subsystem. Transformers may automatically control, via OLTCs, a tap position up or down (e.g., adjust a tap setting by increasing or decreasing the tap setting that the transformer generates signals based on), which may increase or decrease the downstream bus voltage to be within a relatively small deadband around the bus voltage target setpoint (e.g., setpoint parameter), where the relatively small deadband corresponds to range region 706 (e.g., R1^{±}) and/or to range region 704 (e.g., R2^{±}). The data processing system 202 may handshake controlling bus voltage through the one or more generator and the one or more transformers based on which is associated with a higher priority control objective (e.g., in the control objective priorities 220 data). This control objective may apply to a target subsystem with at least 1 transformer connected to the target subsystem and at least 1 generator connected to the same target subsystem.

The second additional control objective may correspond to power factor control at a point of common coupling (PCC) with the utility 352 using one or more transformers and/or one or more generators coupled to a target subsystem. Transformers may automatically control, via OLTCs, a tap position up or down (e.g., adjust a tap setting by increasing or decreasing the tap setting that the transformer generates signals based on), which may increase or decrease the power factor across the PCC. This may be controlled to be within a relatively small deadband around a power factor target setpoint (e.g., setpoint parameter), where the relatively small deadband corresponds to range region 706 (e.g., R1^{±}) and/or to range region 704 (e.g., R2^{±}). Generators may provide reactive power (Q) to increase or decrease the power factor across the PCC. This may be controlled to be within a relatively small deadband around a reactive power (Q) (e.g., setpoint parameter), where the relatively small deadband corresponds to range region 706 (e.g., R1^{±}) and/or to range region 704 (e.g., R2^{±}). This control objective may apply to a target subsystem with at least 1 transformer and/or at least 1 generator connected to the target subsystem.

In some systems, the data processing system 202 may generate autonomous control instructions 214 based on the control objective data 216. The instructions 214, when executed, may cause the data processing system 202 to implement the control objective operations with the first priority integrated. The data processing system 202 may use real-time determinations to evaluate whether to execute respective of the various control objectives, as opposed to determining whether to execute when generating the first order relative to a first of N subsystems. For example, FIGS. 13-17 integrate the real-time determinations to evaluate whether to execute respective of the various control objectives while performing respective control operations in an order that implements the priority of the various control objectives (e.g., operations of FIG. 13 being performed before operations of FIG. 17, thereby implementing a priority of the various control objectives that may associate operations of FIG. 13 with a higher priority), as opposed to determining whether to execute when generating the first order (e.g., such as at operations of process blocks 240 or 378). In some cases, the memory 204 may be loaded during manufacturing of the control system 200 with the instructions 214 that implement the control objective operations with the first priority integrated, where during execution, the data processing system 202 may use real-time determinations to evaluate whether to execute respective of the various control objectives.

For example, a tangible, non-transitory, computer-readable medium may store instructions that, when executed by the data processing system 202, cause the control system 200 to perform operations. The operations may include accessing instructions for autonomous control of an electric power delivery system, where the instructions may indicate multiple control objectives implemented in a first order based on an interconnection between a device and a subsystem of the electric power delivery system (e.g., based on a topology of the electric power delivery system indicated by the association data 212). The operations may include receiving field system data 210 associated with the present operation of the electric power delivery system. The operations may include determining that the present operation of a first subsystem of the one or more subsystems is outside a control objective range of the control objective ranges 222. The operations may include generating one or more control signals to adjust operation of one or more devices of the first subsystem based on determining that the present operation of the first subsystem is outside the control objective range. The operations may additionally include generating instructions for electric power delivery system autonomous control at least in part by determining the first order in which to implement the control objectives based on accessing association data 212, accessing control objective data 216, determining the first order through which to implement the multiple control objectives based on the relative priority between the control objectives and the one or more associations, and generating the instructions for electric power delivery system autonomous control to implement the multiple control objectives in the first order at the electric power delivery system. The operations may additionally include receiving an indication of change in electric power delivery system, re-generating the instructions for electric power delivery system autonomous control relative to the change in the electric power delivery system.

Technical effects of the present disclosure include increased reliability and reduced computing resources spent programming and reprogramming control systems of an electric power delivery system based on real time changes in operation and/or configuration. For example, although a ring bus configuration adds resiliency and reliability to an electric power delivery systems, the ring bus configuration adds complexity in that the topology is to be tracked, the transformers tapped, and the generator controlled in a control scheme that reduces or removes fighting between the transformers and the generators as both controlling the same voltage objective. A control system may access control objective data that identifies a relative priority between multiple control objectives according to which to operate the electric power delivery system. By using priorities, different orders of control objectives may be used for different topologies, which may enable changing priorities among the different topologies without changing an underlying control algorithm. In the ring bus configuration, the control system may control the voltage objective of the electric power delivery system while doing so in a manner that reduces or eliminates any contradictory adjustments to transformers and generators.

While specific embodiments and applications of the disclosure have been illustrated and described, it is to be noted that the disclosure is not limited to the precise configurations and devices disclosed herein. For example, the systems and methods described herein may be applied to an industrial electric power delivery system or an electric power delivery system implemented in a boat or oil platform that may or may not include long-distance transmission of high-voltage power. Accordingly, many changes may be made to the details of the above-described embodiments without departing from the underlying principles of this disclosure. The scope of the present disclosure should, therefore, be determined only by the following claims.

Indeed, the embodiments set forth in the present disclosure may be susceptible to various modifications and alternative forms, specific embodiments have been shown by way of example in the drawings and have been described in detail herein. However, it may be noted that the disclosure is not intended to be limited to the particular forms disclosed. The disclosure is to cover all modifications, equivalents, and alternatives falling within the spirit and scope of the disclosure as defined by the following appended claims. In addition, the techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). For any claims containing elements designated in any other manner, however, it is intended that such elements are not to be interpreted under 35 U.S.C. 112(f).

What is claimed is:

1. An electric power delivery system, comprising:
one or more subsystems configured to distribute power to one or more devices; and
a control system communicatively coupled to the one or more devices, wherein the control system is configured to:
access control objective data that indicates a relative priority between a plurality of control objectives to be implemented across the one or more subsystems;
determine a first order in which to implement the plurality of control objectives based on the relative priority between the plurality of control objectives and based on one or more associations between respective devices of the one or more devices and respective subsystems of the one or more subsystems; and
generate one or more control signals configured to implement the plurality of control objectives in the first order.

2. The electric power delivery system of claim 1, wherein the one or more subsystems comprise one or more disconnect switches respectively configured to connect respective devices of the one or more devices to the one or more subsystems, and wherein the control system is configured to access the associations between respective devices of the one or more devices and respective subsystems of the one or more subsystems based on identifying respective interconnections between the one or more devices and the one or more subsystems.

3. The electric power delivery system of claim 1, wherein the control system is configured to implement the plurality of control objectives sequentially according to the first order in each of the one or more subsystems over at least partially overlapping time durations.

4. The electric power delivery system of claim 3, wherein the control system is configured to implement the plurality of control objectives based on:
determining that a first-in-priority control objective of the plurality of control objectives is not completed relative to a first subsystem of the one or more subsystems; and
generating a control signal to cause an adjustment in a power delivered by the electric power delivery system based on the first-in-priority control objective relative to the first subsystem.

5. The electric power delivery system of claim 4, wherein the control objective data comprises indications of the first-in-priority control objective having a relatively greater priority than a second-in-priority control objective.

6. The electric power delivery system of claim 1, wherein the control objective data comprises, as the plurality of control objectives, an indication of a voltage threshold by which to perform transformer tapping voltage control, generator voltage control, generator reactive power control, generator reactive power sharing, circulating current minimization, or any combination thereof.

7. The electric power delivery system of claim 1, wherein the one or more devices comprises a transformer, wherein a first-in-priority control objective of the plurality of control objectives corresponds to maintaining a voltage bus of the transformer between a first voltage range and not to exceed beyond a second voltage range.

8. The electric power delivery system of claim 1, wherein the control system comprises a central monitoring system.

9. A method comprising:
accessing association data configured to identify one or more associations between respective devices of one or more devices and respective subsystems of one or more subsystems of an electric power delivery system;
accessing control objective data configured to identify a relative priority between a plurality of control objectives of the electric power delivery system;
determining a first order through which to implement the plurality of control objectives based on the relative priority between the plurality of control objectives and the one or more associations; and
generating one or more control signals configured to implement the plurality of control objectives in the first order at the electric power delivery system.

10. The method of claim 9, wherein generating the one or more control signals comprises generating a plurality of control signals configured to implement the plurality of control objectives sequentially according to the first order in each of the one or more subsystems over at least partially overlapping time durations.

11. The method of claim 9, wherein generating the one or more control signals comprises generating a control signal configured to cause an adjustment in a respective device of a respective subsystem of the one or more subsystems based on:
receiving field system data associated with the one or more subsystems;
determining, based on the field system data, that a first-in-priority control objective of the plurality of control objectives is not completed relative to the respective subsystem; and
determining the adjustment to apply to an operational parameter of that respective device based on the field system data and the first-in-priority control objective.

12. The method of claim 9, comprising:
receiving field system data associated with the one or more subsystems;
determining, based on the field system data, that each control objective of the plurality of control objectives is addressed relative to each respective subsystem of the one or more subsystems; and:
generating a completed indication based on determining that each control objective of the plurality of control objectives is addressed relative to each respective subsystem of the one or more subsystems.

13. The method of claim 12, wherein determining, based on the field system data, that each control objective of the plurality of control objectives is addressed relative to each respective subsystem of the one or more subsystems comprises:
determining that a first subsystem of the one or more subsystems is within a voltage range associated with a first-in-priority control objective of the plurality of control objectives; and
determining that a second subsystem of the one or more subsystems is within the voltage range associated with the first-in-priority control objective of the plurality of control objectives.

14. The method of claim 9, wherein accessing the control objective data comprises:
receiving an indication of a voltage threshold by which to perform transformer tapping voltage control, generator voltage control, generator reactive power control, generator reactive power sharing, circulating current minimization among two or more parallel transformers, or any combination thereof; and
receiving instructions for respective control objectives of the plurality of control objectives, wherein, the instructions, when executed by processing circuitry, cause performance of transformer tapping voltage control, generator voltage control, generator reactive power control, generator reactive power sharing, circulating current minimization among two or more parallel transformers, or any combination thereof.

15. A tangible, non-transitory, computer-readable medium comprising instructions that, when executed by a data processing system, causes a control system to perform operations comprising:
generating association data configured to identify one or more associations between respective devices of one or more devices and respective subsystems of one or more subsystems of an electric power delivery system;
accessing control objective data configured to identify a relative priority between a plurality of control objectives of the electric power delivery system;
determining an adjustment based on the relative priority between the plurality of control objectives and the one or more associations between the respective devices and the respective subsystems; and
generating one or more control signals configured to implement the adjustment at the one or more devices.

16. The tangible, non-transitory, computer-readable medium of claim 15 comprising instructions that, when executed by the data processing system, causes the control system to perform the operations, wherein the operations comprise generating the one or more control signals configured to implement the adjustment at the one or more devices based on:
determining that a first-in-priority control objective of the plurality of control objectives is not completed relative to a first subsystem of the one or more subsystems; and
generating a control signal to cause an adjustment in a power delivered by the electric power delivery system based on the first-in-priority control objective relative to the first subsystem.

17. The tangible, non-transitory, computer-readable medium of claim 16 comprising instructions that, when executed by the data processing system, causes the control system to perform the operations, wherein the operations comprise accessing the control objective data based on accessing a control objective priority data comprising an indication of the first-in-priority control objective having a relatively greater priority than a second in priority control objective.

18. The tangible, non-transitory, computer-readable medium of claim 15 comprising instructions that, when executed by the data processing system, causes the control system to perform the operations, wherein the operations comprise accessing the control objective data based on accessing a control objective range data comprising an indication of a voltage threshold by which to perform transformer tapping voltage control, generator voltage control, generator reactive power control, generator reactive power sharing, circulating current minimization among two or more parallel transformers, or any combination thereof.

19. The tangible, non-transitory, computer-readable medium of claim 15 comprising instructions that, when executed by the data processing system, causes the control system to perform the operations, wherein the operations comprise generating the one or more control signals configured to adjust a voltage bus of a transformer of the one or more devices to reduce a voltage of the voltage bus to below a first voltage range.

20. The tangible, non-transitory, computer-readable medium of claim 19 comprising instructions that, when executed by the data processing system, causes the control system to perform the operations, wherein the operations comprise generating an additional control signal configured to adjust the voltage bus of the transformer to increase the voltage of the voltage bus outside the first voltage range and within a second voltage range.
